(19) United States
(12) Patent Application Publication
(10) Pub. No.: US 2024/0232937 A1
(43) Pub. Date: Jul. 11, 2024

(54) SYSTEM AND METHODS UTILIZING GENERATIVE AI FOR OPTIMIZING TV ADS, ONLINE VIDEOS, AUGMENTED REALITY & VIRTUAL REALITY MARKETING, AND OTHER AUDIOVISUAL CONTENT

(71) Applicant: Timothy Christopher D'Auria, Sharon, MA (US)

(72) Inventor: Timothy Christopher D'Auria, Sharon, MA (US)

(73) Assignee: VIDEOQUANT INC, Boston, MA (US)

(21) Appl. No.: 18/440,543

(22) Filed: Feb. 13, 2024

Related U.S. Application Data
(60) Provisional application No. 63/445,767, filed on Feb. 15, 2023.
(60) Provisional application No. 63/452,215, filed on Mar. 15, 2023.

(51) Int. Cl. G06Q 30/0242; G06N 3/0475

(52) U.S. Cl. CPC G06Q 30/0244; G06N 3/0475

(57) ABSTRACT

This invention presents a system and methods for optimizing audiovisual content, including TV commercials, online videos, and AR/VR marketing, using generative models. It processes varied audiovisual data, generating an intermediary output that captures key elements like color schemes, audio patterns, entity interactions, and narrative structures. The system's attribute recognition module, combined with an effectiveness measurement module, enables comprehensive pattern recognition, enhancing the creation of optimized content across mediums. It incorporates various AI models, such as LLMs and GPTs, and employs text mining, uncertainty measurement, and SHAP values. The system is adaptable for different performance metrics, such as advertising effectiveness and ROI. This approach streamlines the audiovisual content development process, reducing time and costs, and is applicable in television, online video production, social media advertising, and AR/VR marketing.

### CROSS-REFERENCE TO RELATED APPLICATIONS

This application is related to the following four (4) prior patent applications: U.S. patent application Ser. No. 17/727,088, filed on Apr. 22, 2022, U.S. Provisional Patent Application Ser. No. 63/183,098, filed on May 2, 2021, U.S. Provisional Patent Application Ser. No. 63/44,5767, filed on Feb. 15, 2023, and U.S. Provisional Patent Application Ser No. 63/45,2215, filed on Mar. 15, 2023. The entire contents of each of these applications are hereby incorporated by reference in their entirety for all purposes. For brevity, these applications are herein referred to as the “Related Applications” or “Video Optimization System.”

The present application and the referenced applications may share similar subject matter, including techniques, methods, and systems for using machine learning to predict video performance, as well as other related aspects of artificial intelligence, machine learning, and natural language processing. The referenced applications may provide additional background, context, or technical details that supplement and enhance the present application.

The present application may further expand on, improve, or modify the technologies and methods disclosed in the referenced applications, providing novel and inventive solutions to the problems addressed therein. Incorporating the referenced applications by reference allows for a more comprehensive understanding of the present application and its relationship to the state of the art and prior innovations in the field.

### FIELD OF THE INVENTION

The present invention relates to the field of video content analysis and optimization, particularly to the detection of attributes within TV commercials, paid video ads, organic online video, and other multimedia formats, and the use of these attributes to predict new TV commercials and other video content likely to succeed at optimizing one or more performance metrics such as return on investment.

### BACKGROUND OF THE INVENTION

The field of audiovisual content creation and optimization has undergone significant evolution, driven primarily by advancements in artificial intelligence (AI) and machine learning (ML). In recent years, the proliferation of digital media, including online videos, television commercials, and the burgeoning domains of augmented reality (AR) and virtual reality (VR), has necessitated innovative approaches to content development and optimization.

Traditionally, the creation and evaluation of audiovisual content have been resource-intensive tasks, relying heavily on human expertise and subjective judgment. This approach, while effective to an extent, presents limitations in terms of scalability, cost, and time efficiency. Moreover, the subjective nature of human evaluation often leads to inconsistent outcomes and challenges in accurately predicting content effectiveness.

In response to these challenges, various AI and ML techniques have been employed to analyze and optimize audiovisual content. Early systems focused on basic video analysis, using techniques like color pattern recognition, audio analysis, and simple pattern identification. However, these systems were limited in their capacity to understand complex narrative structures, emotional engagement, and viewer interaction patterns, which are crucial elements in determining the effectiveness of audiovisual content.

The advent of advanced AI models, such as Large Language Models (LLMs), Generative Pre-trained Transformers (GPTs), and other sophisticated machine learning algorithms, marked a significant turning point in this field. These models have the capability to process vast amounts of data, learn from diverse content types, and generate predictive models that can effectively analyze and optimize audiovisual content. Their application extends beyond traditional media to include interactive and immersive content types like AR and VR, which are rapidly gaining prominence in marketing and entertainment.

Despite these advancements, there exists a need for a comprehensive system that seamlessly integrates these AI and ML capabilities to optimize audiovisual content across various platforms and formats. Such a system should not only analyze existing content but also generate predictive insights that guide the creation of new, optimized content. This includes the ability to process and understand the intricacies of AR and VR content, which present unique challenges in terms of spatial dynamics, viewer interaction, and immersive experience.

The present invention addresses these needs by providing an integrated system that employs advanced AI and ML techniques for the optimization of audiovisual content. Building upon the foundations laid by related prior patent applications, this invention introduces novel methodologies and systems for processing, analyzing, and generating optimized audiovisual content, including but not limited to TV commercials, online videos, and AR/VR marketing materials. The system's unique approach to attribute recognition, effectiveness measurement, and pattern recognition, supported by state-of-the-art AI models and data processing techniques, represents a significant advancement in the field of audiovisual content optimization.

### SUMMARY OF THE INVENTION

This invention represents a significant advancement in the field of video optimization, building upon the foundational work presented in the Related Applications. It introduces innovative methodologies, particularly in Attribute Recognition 108, Pattern Recognition 114, and Output Generation 116, as expounded in U.S. Provisional Patent Application Ser. Nos. 63/45,2215 and 63/44,5767. The invention emphasizes the use of Generative Models, a broad category of machine learning models, for processing and optimizing audiovisual content, including advancements in handling augmented reality (AR) and virtual reality (VR) content.

In Attribute Recognition 108, the system utilizes Generative Models to process various inputs such as images, audio, video, and more complex formats like AR and VR. These models transform these inputs into lower dimensional representations, termed as descriptive intermediaries. These intermediaries describe the multimedia data's attributes retrieved by Data Retrieval 106 and are pivotal for subsequent analysis in Pattern Recognition 114. They can be directly employed in Pattern Recognition 114 or undergo additional processing like encoding or conversion into a term-document matrix.

The creation of descriptive intermediaries through Generative Models includes methods like general instructions to describe multimedia elements and iterative prompting using stored explicit questions in Memory 102. These questions cover a broad spectrum, from basic scene descriptions to the identification of intricate elements and interactions within AR and VR environments.

Pattern Recognition 114 leverages data from Data Storage 104, encompassing multimedia attributes and effectiveness measurements. The Generative Models analyze data to identify patterns between attributes and performance metrics of the videos. This involves passing data and specific prompts to the models to detect attributes that effectively drive performance metrics, with a particular focus on the unique dynamics and interactions present in TV commercials, social video, and AR/VR content.

In Output Generation 116, Generative Models are instrumental in transforming insights from Pattern Recognition 114 into tangible multimedia outputs, including those tailored for AR and VR platforms. By inputting recognized patterns into these models along with targeted prompts, the system generates optimized content such as text descriptions, scripts, storyboards, and complete audiovisual content, including immersive AR and VR experiences.

The system's ability to handle AR and VR content addresses specific challenges in these domains, such as the complexity of creating immersive and interactive experiences, the need for rapid adaptation to evolving technologies, and the integration of multi-sensory elements into cohesive narratives.

In summary, this invention employs Generative Models across three critical areas: transforming multimedia inputs into lower-dimensionality descriptive representations for better analysis and interpretation; identifying patterns in attributes related to performance metrics in Pattern Recognition 114; and generating optimized multimedia content in Output Generation 116.

By leveraging AI and Generative Models in these innovative ways, the invention overcomes challenges in traditional video content production and offers enhanced capabilities for creating impactful and engaging content in both traditional media and emerging AR/VR platforms. This approach marks a significant advancement in video optimization, aligning with and extending the disclosures of the Related Applications.

The practical impact of the invention on marketing, particularly in eliminating the cost of guesswork, is substantial and multifaceted:
a. Reduction in Trial-and-Error Costs: The invention allows users to bypass the costly and inefficient “trial and error” approach prevalent in current audiovisual marketing practices. By using insights derived from competitors' spending and the invention's predictive capabilities, businesses can focus only on concepts likely to succeed, thus saving significant resources.
b. Novel Financial Benefit: Users of the invention can benefit financially from their competitors' marketing expenditures. As competitors invest in video marketing, the invention enables users to learn from these investments, reducing their own cost-to-learn ratio for video marketing to nearly zero. This approach represents a significant strategic advantage.
C. Elimination of Upfront Investment: Traditional approaches require substantial upfront investment in video content creation and testing, often leading to financial infeasibility. The invention eliminates the need for such investments, enabling brands to avoid potentially millions of dollars in marketing failures while achieving similar benefits without the associated costs.
d. Automated Content Generation for Strategic Purposes: By automating the content creation process, the invention allows businesses to save time and money while producing high-quality, optimized video content for strategic marketing purposes like customer acquisition and revenue generation. This automation reduces the time and costs associated with commercial production while delivering effective advertisements.
e. Predictive Power Over Video Content Performance: The invention provides a mechanism to predict video themes and attributes most likely to succeed in achieving performance objectives, even before any financial commitment to video advertising or content creation. This predictive capability leads to more effective and targeted marketing efforts.
f. Cost Savings and Reduced Ad Failure Rate: Early testing of the invention indicates a potential reduction in video ad failure rates by over 40 percentage points compared to the status quo. This reduction could lead to substantial cost savings for large video advertisers, potentially amounting to over $1 billion per year.

In summary, the invention's practical impact on marketing is transformative. It significantly reduces the reliance on costly guesswork and trial-and-error methods, enables strategic and cost-effective video content creation, and leverages competitive intelligence to enhance marketing effectiveness. This represents a paradigm shift in how video content is ideated, produced, and optimized for marketing purposes.

### BRIEF DESCRIPTION OF DRAWINGS

The accompanying drawings, which are incorporated in and constitute a part of this specification, illustrate several embodiments of the invention and, together with the description, serve to explain the principles of the invention. The drawings are only for the purpose of illustrating preferred and alternative examples of how the invention can be made and used and are not to be construed as limiting the invention to only those embodiments illustrated and described. The various aspects and features of the present invention will be better understood with regard to the following detailed description and drawings where:

FIG. 1: Depicts a schematic representation of the Video Optimization System as disclosed in Related Applications. This figure details the interconnected roles of primary computing components such as the Processor and Memory, along with functional modules including Data Retrieval, Attribute Recognition, Effectiveness Measurement, Pattern Recognition, and Output Generation, illustrating their synergistic operation within the system.

FIG. 2: Illustrates an implementation of Visual Question Answering (VQA) within the attribute recognition 108 module. This figure delineates the interaction of VQA models with various prompts to accurately identify and extract specific features from multimedia content, thereby facilitating efficient attribute extraction and subsequent analysis.

FIG. 3: Focuses on an alternate methodology for attribute recognition 108 employing image description techniques. This figure demonstrates the processing of multimedia content inputs by a generative model, resulting in the creation of descriptive textual intermediaries that contribute significantly to the attribute analysis process.

FIG. 4: Details a refinement process of textual intermediaries derived from image captioning through the application of text mining techniques. This figure emphasizes the transformation of unstructured textual data into structured, analyzable formats, thereby augmenting the analysis of multimedia content.

FIG. 5: Illustrates a unified method for attribute recognition 108, combining the techniques described in FIG. 2, FIG. 3, and FIG. 4. This figure showcases the use of various AI models and text mining methods to thoroughly analyze and understand audiovisual data, which in certain cases may include augmented reality (AR) and/or virtual reality (VR) data.

FIG. 6: Illustrates the integration of outputs from the attribute recognition 108 module with those from the effectiveness measurement 110 module. This synergy is depicted as pivotal for the ensuing pattern recognition 114 process, aiding in the identification of relationships between audiovisual attributes and key performance metrics.

FIG. 7: Showcases a specific machine learning dataset structure tailored for pattern recognition 114. This figure focuses on the incorporation of multimedia identifiers and outputs from text mining as features, along with a target performance metric, to facilitate pattern recognition 114 analysis.

FIG. 8: Depicts an alternative format for a machine learning dataset utilized in pattern recognition 114. This figure highlights the utilization of textual intermediary attributes as features and includes a target metric for comprehensive analysis.

FIG. 9: Introduces a distinctive embodiment for the machine learning dataset, where multimedia content is directly used as an input feature. This figure also includes standard identifiers and target columns, underscoring a novel approach for pattern recognition 114 analysis.

FIG. 10: Demonstrates the fine-tuning of a generative model within the pattern recognition 114 component. This figure shows the adaptation of the model to process numeric attributes derived from text mining, enabling the generation of effectiveness scores for various forms of audiovisual content as a part of Output Generation 116.

FIG. 11: Showcases a generative model, specifically fine-tuned in Pattern Recognition 114, to accept textual intermediary attribute input and produce effectiveness scores, forming a part of Output Generation 116.

FIG. 12: Demonstrates a generative model, adeptly fine-tuned in Pattern Recognition 114, for processing multimedia attribute input and outputting effectiveness scores, under the ambit of Output Generation 116.

FIG. 13: Highlights the methodology employed for fine-tuning generative models within the system. This figure elucidates the process of reformatting data into JSON messages for training purposes, enhancing the model's ability to generate desired predictions.

FIG. 14: Illustrates an exemplary embodiment of Web Portal 118, displaying effectiveness predictions derived from the system's analytical processes to end-users, utilizing a conceptual scenario of evaluating a television commercial based on the output from Output Generation 116.

FIG. 15: Illustrates the ranking process of predicted effectiveness within the output generation 116 stage. This figure delineates how output scores are subjected to ranking, sorting, or reordering to effectively organize the data for presentation to users.

FIG. 16: Demonstrates a method of iterative performance refinement within the output generation 116 component. This figure showcases the integration of a generative model with a fitted model, enhancing the predictive process and optimizing the generation of audiovisual content ideas.

FIG. 17: Explores the use of pre-trained generative models in conjunction with various input types, such as model scores and guidance prompts, for generating user output within the output generation 116 component. The figure illustrates the generation of strategic insights for effective content creation.

FIG. 18: Focuses on the incorporation of SHAP values from a fitted model into a generative model. This figure elucidates how SHAP values, representing feature significance in predictions, are utilized to generate actionable suggestions for commercial concepts as part of the output generation 116 component.

FIG. 19: Demonstrates the innovative process of inputting a fitted model itself into a generative model, accompanied by a guidance prompt. This figure exemplifies the utilization of the fitted model's structure and learned patterns to generate targeted guidance for content creation as part of the output generation 116 component.

FIG. 20: Showcases the application of a machine learning training dataset as input to a generative model. This figure highlights the direct processing capability of the generative model on ML training data to predict commercially viable television commercial concepts based on estimated ROI as part of output generation 116.

FIG. 21: Presents a process where a guidance prompt is utilized to generate optimized multimedia outputs, such as television commercials, via a fine-tuned generative model. This figure emphasizes the model's adeptness at transforming diverse inputs into specifically tailored multimedia products to maximize performance metrics.

FIG. 22: Illustrates the generative model's functionality in creating optimized scripts for television commercials. The model processes specific guidance prompts and produces scripts aligned with high-scoring predictions and strategic objectives.

FIG. 23: Depicts the display functionality of web portal 118, showcasing output from a generative model specifically fine-tuned for generating optimized television commercial scripts.

This interface design facilitates user input of specific guidance and displays corresponding outputs tailored to their requirements.

FIG. 24: Showcases an alternative format for displaying output scripts within web portal 118. This format adheres to traditional standards, segregating video and audio components, and demonstrates the system's adaptability in information presentation.

FIG. 25: Displays the web portal's capability to present optimized video content recommendations, ordered according to model scores. This figure illustrates the system's proficiency in generating and ranking new television commercial concepts based on their predicted performance.

FIG. 26: Extends the concept of video content recommendations to focus on concepts to be avoided, based on their ranking by model scores. This feature aids users in identifying and prioritizing content with the lowest predicted ROI.

FIG. 27: Demonstrates the web portal's ability to render an outline for a new television commercial. This feature allows users to select a concept and receive a detailed outline generated by a generative model for their chosen video topic.

FIG. 28: Depicts a user interface within web portal 118 for entering and evaluating new television commercial concepts. The portal provides scores and confidence bands for each concept, aiding in the decision-making process for multimedia content creation.

FIG. 29: Shows the interface following a user's selection of a concept for content creation. This screen facilitates user input of specific parameters for a television commercial and displays a script generated for the selected concept.

FIG. 30: Showcases the application of a Web API exposed by web portal 118, demonstrating the integration of generative models for content creation, specifically for generating optimized television commercial scripts.

FIG. 31: Illustrates an advanced implementation of transfer learning using rank-based results data. This figure focuses on the use of semantic expansion and video search queries for identifying competitive threats and evaluating video effectiveness.

FIG. 32: Exemplifies the computation of confidence bands and other measures of uncertainty on scores within the video optimization system. It details two methodologies, bootstrapping and quantile regression, for calculating these confidence bands.

FIG. 33: Introduces a method of utilizing efficient similarity search on audio-visual attributes alongside computed scores and confidences to expedite the output generation process.

This approach enables rapid response times for predictions on new inputs.

FIG. 34: Demonstrates the use of a central tendency in conjunction with efficient similarity search for variance computation in output generation. It showcases an advanced method for scoring new data using prebuilt indexes.

FIG. 35: Exemplifies the operation of data retrieval 106, detailing the specific operational steps within this component. It demonstrates the versatile and iterative nature of data retrieval in expanding the pool of content used for analysis.

FIG. 36: Presents a method of reordering data retrieval operation 106 and incorporating aggregation by brand. This approach aids in identifying key brands and influencers relevant to the audiovisual optimization for a user.

FIG. 37: Outlines a method employing similarity-based machine learning and a feature hashing technique. This process is designed for rapidly identifying competitors and relevant influencers in the domain of audiovisual content.

FIG. 38: Showcases a method for prioritizing operations using the coefficient of variation and other variability metrics. This approach enhances the efficiency of the video optimization process by focusing on the most informative data.

FIG. 39: Demonstrates an approach to using changes in web search trends in conjunction with video search trends. This method is used to identify competitive threats and evaluate the effectiveness of video content.

FIG. 40: Depicts the embodiment of attribute recognition 108 for processing augmented reality (AR), virtual reality (VR), and higher-dimensionality audiovisual data. This illustration demonstrates how complex multi-dimensional environments, including AR and VR, are systematically reduced into lower-dimension frames for efficient analysis.

These drawings collectively provide a visual understanding of the invention, elucidating its various components, processes, and applications. It is important to note that these figures are intended to facilitate comprehension of the invention's structure, functionality, and methodology, and are not necessarily drawn to scale. They serve as a guide to illustrate the principles and operations of the invention in a clear and concise manner. While they depict the essential aspects of the invention, they may abstract or omit certain details for clarity and simplicity of presentation. The figures should be interpreted in conjunction with the accompanying detailed description, as they are instrumental in providing a comprehensive overview of the invention, but they do not limit the scope of the claims. The specific design choices depicted in these drawings are examples of how the inventive concepts can be implemented and should not be construed as limiting the invention to only those embodiments shown.

### DETAILED DESCRIPTION OF THE INVENTION

Following are terms and phrases that are essential to understanding the scope and implementation of the invention, and are therefore worth defining for clarity and precision in the context of this application.
a. Generative Model: A computational model designed to produce outputs based on a range of input features. It is capable of being trained on extensive public datasets or specific sets of data and can be fine-tuned to process various types of inputs, including numeric attributes, textual intermediaries, and multimedia features, to generate predictions or recommendations related to the effectiveness of audiovisual content. Some examples of generative models as of this writing include:
   i. Large Language Models (LLMs) like GPT (Generative Pre-trained Transformer): These models are specifically trained to understand and generate human language. They can write essays, poems, code, or even mimic a specific writing style. ChatGPT by OpenAI is a notable example, widely recognized for its ability to generate coherent and contextually relevant text based on the input it receives.
   ii. Large Multimodal Models (LMMs): These are a type of advanced artificial intelligence model that is capable of processing and understanding multiple forms of data, or modalities, simultaneously. These modalities can include, but are not limited to, text, images, audio, video, AR, and VR.
   iii. Variational Autoencoders (VAEs): These are primarily used for image generation and modification. VAEs can learn to encode images into a lower-dimensional space and then generate new images by decoding from this space.
   iv. Generative Adversarial Networks (GANs): Widely used in image generation, GANs involve two neural networks a generator and a discriminator that are trained simultaneously. The generator creates new data samples, while the discriminator evaluates their authenticity.
   v. Convolutional Neural Networks (CNNs) for Image Generation: While CNNs are more commonly known for image recognition tasks, they can also be trained to generate new images, often producing high-quality and detailed visuals.
   vi. Recurrent Neural Networks (RNNs) for Sequence Generation: RNNs are adept at handling sequential data and are often used for tasks such as text generation, where understanding the sequence of words is crucial.
   vii. Transformer Models for Various Types of Data Generation: Beyond text, transformer models can be adapted for other types of data like music and speech synthesis, showcasing their versatility in handling different forms of sequential data.
b. Audiovisual Content: Encompasses multimedia materials that combine visual and auditory elements for various purposes. This includes but is not limited to marketing and advertising materials such as television commercials, social videos, online videos, online video advertisements, earned media, and augmented reality (AR) & virtual reality (VR) marketing content.
c. JSON Messages: A data format used for structuring data in a text format that is easy for machines to parse and generate. In the context of this system, JSON messages are used to format data for training generative models, encapsulating essential elements of datasets for enhancing the model's predictive capabilities.
d. SHAP Values (SHapley Additive exPlanations): A method based on game theory used to explain the output of machine learning models. It assigns importance values to each feature of a model, indicating their contribution to the model's prediction. In this system, SHAP values are used to understand the impact of various features on the predictive outcomes of generative models.
e. Machine Learning Training Dataset: A collection of data used to train machine learning models. It typically includes features (input variables) and a target variable (output). The dataset is used by generative models to learn patterns and relationships within the data, enabling them to make accurate predictions or generate recommendations for audiovisual content.
f. Confidence Bands: Statistical ranges within which a true parameter value for a given level of confidence is expected to fall. In this system, confidence bands are used to indicate the reliability or uncertainty of effectiveness scores produced by generative models, providing a measure of confidence in the predictions.
g. Semantic Expansion: A process of generating a broader set of related concepts or terms based on a given input term. It involves expanding the scope of a topic to include various related subjects or keywords, enhancing the comprehensiveness of data retrieval and analysis.
h. Feature Hashing Technique: A method for converting a large number of possibly correlated features into a smaller, manageable representation. In this system, feature hashing is used to rapidly process and retrieve brands and influencers producing similar audiovisual content, enhancing the efficiency of identifying relevant content.
i. Coefficient of Variation (CV): A statistical measure of the relative variability or dispersion of data points in a dataset. It is calculated as the ratio of the standard deviation to the mean. In this context, the CV is used to prioritize operations by identifying brands with videos that exhibit significant variability in performance, indicating potential for learning and optimization.
j. Bootstrapping: A statistical method used for estimating the distribution of a statistic (e.g., mean, median) by sampling with replacement from the data. It is employed in this system to generate confidence bands for effectiveness scores, aiding in the assessment of score reliability.
k. Quantile Regression: A type of regression analysis used in statistics to estimate the conditional quantiles of a response variable distribution. In the context of this system, it is used to calculate confidence bands for scores, enabling the assessment of prediction reliability at various quantiles.
l. Indexing and Similarity Search: Processes used to organize data (indexing) and find similar items within this data (similarity search). In this system, they are employed to rapidly identify brands and influencers producing content similar to a user's interest, enhancing content optimization and competitive analysis.

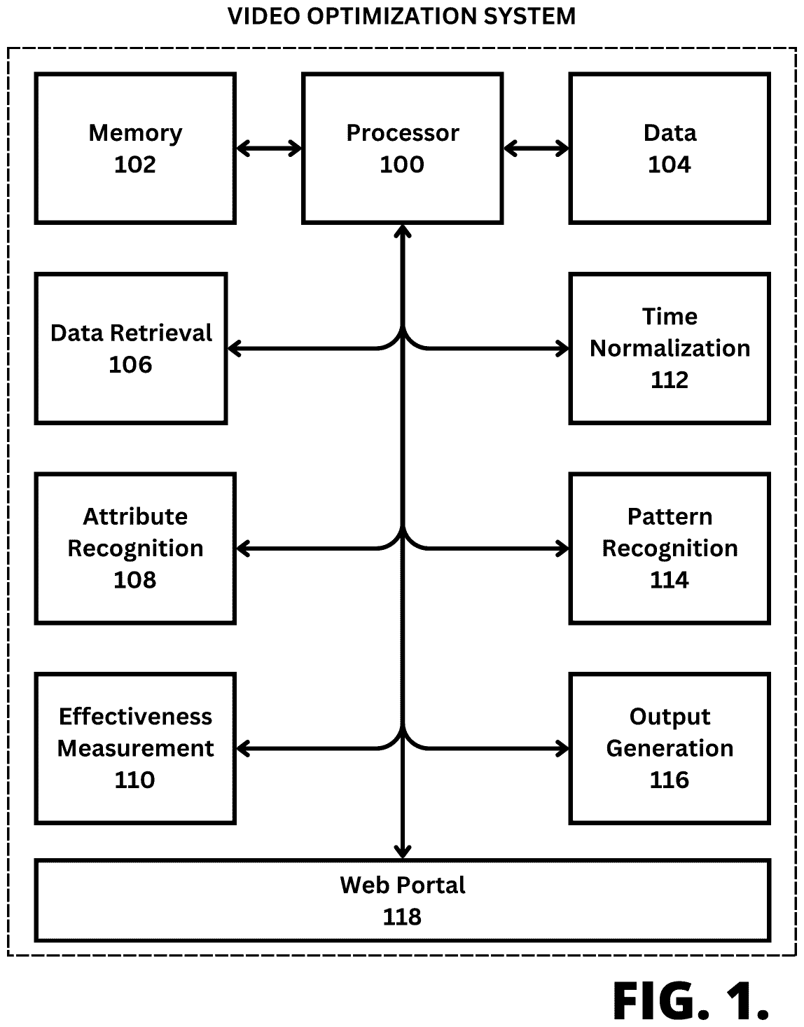

Referring now to the drawings, FIG. 1 illustrates an overview of a video optimization system as previously disclosed in Related Applications, included here for contextual reference and comprehensive understanding. FIG. 1 provides a schematic representation of the various components and their interconnectivity within the video optimization system.

At the core of this system lies Processor 100, which is the primary computing unit responsible for executing instructions, processing data, and managing the operations of the system. The Processor 100 is connected to Memory 102, a storage component that retains both the instructions for the operations of the Processor 100 and the data necessary for these operations. Data 104 represents the collective information, including both raw and processed data, used and generated by the system. This data is crucial for the functioning of the system as it includes video content, audio-visual media attributes, and performance metrics.

Notably, the term “processor” as used herein encompasses various forms of processing units including, but not limited to, Central Processing Units (CPUs) and Graphics Processing Units (GPUs). GPUs, in particular, are specialized electronic circuits designed to rapidly manipulate and alter memory to accelerate the creation of images in a frame buffer intended for output to a display device. In the context of this system, a GPU can be utilized to enhance the processing of complex video content, especially when dealing with high-resolution media or intricate computational tasks associated with video generation and optimization.

Data Retrieval 106 is a significant operation within the system, tasked with the gathering of data from various sources. This operation is fundamental as the effectiveness and accuracy of the system largely depend on the quality and relevance of the data retrieved.

Attribute Recognition 108 is a critical process where video and other audio-visual media are analyzed to mine attributes. This process involves the identification and extraction of various characteristics and features from the audio-visual content, which are essential for further analysis and optimization.

Effectiveness Measurement 110 computes the effectiveness of the associated audio-visual media. This component utilizes methodologies disclosed in related applications to evaluate the performance of the media based on predefined metrics. The operations of Effectiveness Measurement 110 are augmented by the Time Normalization Module 112. This module adjusts the calculations of effectiveness based on the temporal aspects of the audio-visual media, such as the time of publication, creation, or other relevant time-related attributes. Such temporal normalization is crucial for ensuring the accuracy and relevance of effectiveness measurements.

Pattern Recognition 114 is responsible for discovering relationships between the attributes mined by Attribute Recognition 108 and the target variables computed by Effectiveness Measurement 110. This process is key to understanding the factors that contribute to the performance of the audio-visual content and for developing predictive models.

Output Generation 116 encompasses model scoring and other associated operations. It processes the insights derived from Pattern Recognition 114 and prepares them for presentation or further utilization. This component is pivotal in translating the analytical findings of the system into actionable outputs.

Lastly, the system includes a Web Portal 118, which serves as an interface for users to access the results. The portal may render the results and provide functionality through associated Application Programming Interfaces (APIs), including RESTful APIs, allowing for integration with other systems and facilitating ease of access and versatility in usage.

In summary, FIG. 1 of the video optimization system provides a comprehensive view of the interconnected components and operations that work in tandem to analyze, measure, and optimize audio-visual content. The system's architecture is designed to leverage advanced computational processes and methodologies for enhancing the effectiveness of multimedia content in various applications.

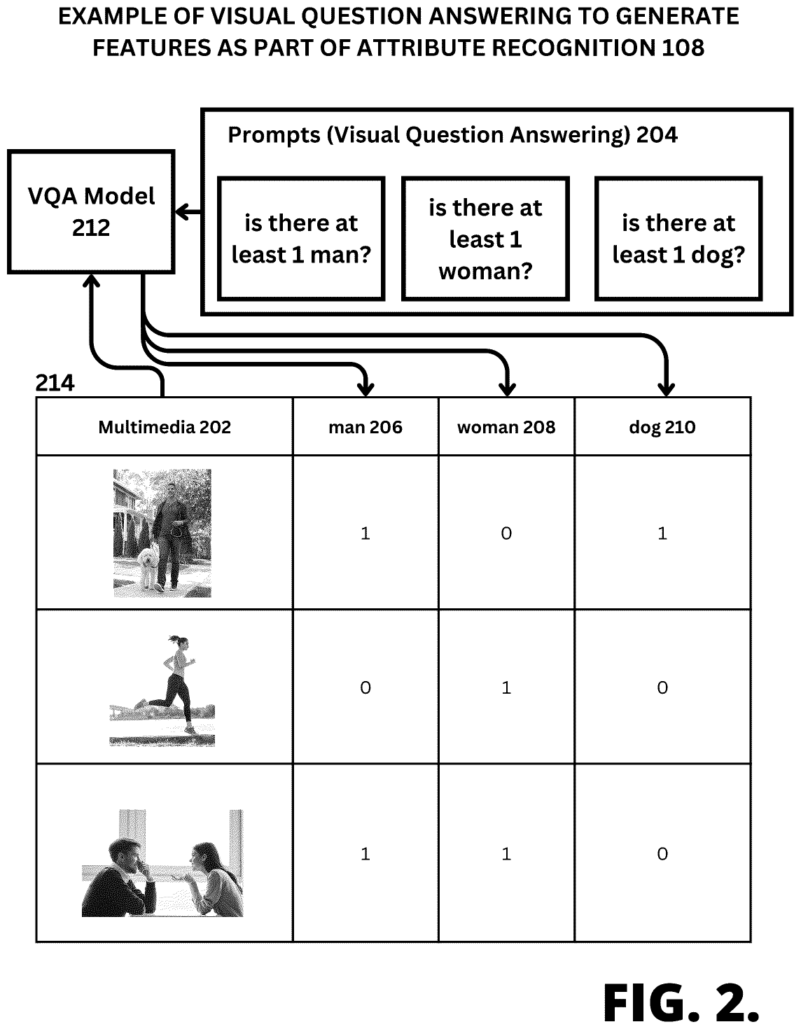

Turning now to FIG. 2, presented therein is an exemplary embodiment of the implementation of visual question answering (VQA) as a component of the attribute recognition process, designated as 108 in the system. This embodiment specifically illustrates the mechanism through which the VQA model, referenced as 212, interacts with various prompts to generate distinct feature for the attribute recognition process.

Prompts 204, as depicted in FIG. 2, represent a series of queries or input stimuli provided to one or more VQA models, collectively denoted as 212. These prompts are strategically designed to elicit specific information relevant to the feature generation process. The prompts facilitate the computation of multiple features, which are methodically cataloged in Table 214, with each feature corresponding to distinct columns labeled 206, 208, and 210.

To elucidate the functionality of this system, consider the following practical example: Table 214 showcases a set of three multimedia inputs, each occupying a cell in the column designated Multimedia 202. While the figure features images in column 202, it is pertinent to note that the inputs to this system can span a broad spectrum of multimedia formats. These formats include, but are not limited to, videos, audio clips, storyboards, slideshows, or any other forms of audio-visual media or their respective components.

In the first instance of Multimedia 202, an image depicting a man walking a white dog outdoors is subjected to analysis by the VQA model 212, in conjunction with Prompts 204. An example prompt provided to the VQA model 212 might be, “Is there at least one man?” In response, the VQA Model 212 processes this prompt and outputs a value of “1”, which is then recorded as the first element in column Man 206 of Table 214. The process continues with a subsequent prompt, “Is there at least one woman?” Here, the VQA Model 212 responds with a “0”, and this data is stored as the first element in column Woman 208 of Table 214. Further, a prompt inquiring, “Is there at least one dog?” is posed, to which the VQA model 212 outputs a “1”, logged in the corresponding row of column Dog 210 in Table 214.

This procedure is systematically repeated for each subsequent multimedia element featured in Multimedia 202, with the VQA model 212 processing each new prompt associated with each element. The outputs thus generated are meticulously recorded in Table 214, populating the columns Man 206, Woman 208, and Dog 210 respectively with the corresponding data.

While not explicitly illustrated in FIG. 2, the implementation of this system often incorporates dependency logic to enhance its efficiency and relevance. For instance, a prompt not shown in the figure might be, “What color is the dog?” In instances where a preceding prompt, such as “Is there at least one dog?” yields a negative response, subsequent prompts related to the attributes of a dog, such as its color, may either be omitted from the process, or the responses generated by the VQA Model 212 for such prompts may be disregarded.

While also not explicitly illustrated in FIG. 2, the implementation of this system often incorporates additional logic to the output of the Visual Question Answering (VQA) Model 212. This logic plays a crucial role in refining and contextualizing the data before its storage in Table 214 or during subsequent processing of Table 214.

One exemplary implementation of this logic is evident in the post-processing of the VQA Model 212 outputs. For instance, in response to the prompt “Is there at least one man?”, if the VQA Model 212 outputs a “yes”, this response can be post-processed and converted into a numerical value, such as a “1”. This conversion facilitates easier and more efficient data handling, particularly when aggregating or comparing features across different multimedia inputs.

In scenarios involving video or any form of motion pictures, this process warrants repetition across one or more frames of the video. The results from each frame are then aggregated to form a comprehensive understanding of the video content. This aggregation can take various forms, such as a consensus view, averaging, and other statistical methods. For instance, consider the prompt “Is there at least one man?”. If in one frame, the VQA Model 212 outputs a “1”, but in two subsequent frames, it outputs “0”, these results can be aggregated to derive a mean value, calculated as (1+0+0)/3. Alternatively, other statistical measures like median or mode can be employed, depending on the specific requirements of the analysis or the nature of the video content.

The chronological sequence of outputs from the VQA Model 212 for different frames of the same audiovisual can be utilized directly to infer actions, events, or changes occurring within the video. This approach is particularly effective in analyzing motion pictures where the temporal progression of frames can reveal significant information about the content.

For example, consider a scenario where the VQA Model 212 is tasked with answering a prompt such as “Where is the car located in the image?” In one frame, the model might output “left” indicating the car's position on the left side of the frame. Subsequently, in a later frame, the model might indicate “right,” showing that the car has moved to the right side. These outputs, especially when analyzed in their chronological order and considering the computed time between frames, can be instrumental in inferring the motion and speed of the car or other dynamic elements in the video.

This chronological analysis allows for a more sophisticated understanding of the video content, going beyond static attributes to capture movement, direction, and temporal changes. It provides a framework for interpreting the sequence of events or actions within the video, thus offering a richer and more detailed analysis.

Incorporating this chronological perspective in the analysis not only enhances the attribute recognition capabilities of the system but also adds a layer of dynamic interpretation, crucial for understanding and optimizing video content that contains elements of motion and change. This approach significantly augments the system's ability to process and interpret complex video sequences, thereby elevating the overall efficacy of the video optimization process.

Collectively, such additional logic and post-processing steps enhance the accuracy and relevance of the attribute recognition process. By applying these methods, the system is better equipped to handle the complexities and variations inherent in video and multimedia content, thereby ensuring more robust and reliable attribute recognition and analysis. This, in turn, significantly contributes to the overall efficacy of the video optimization system, enabling it to produce more precise and actionable insights for video content optimization.

FIG. 2 epitomizes a sophisticated and systematic approach to employing visual question answering in the realm of attribute recognition. This approach not only streamlines the feature generation process but also ensures the relevance and accuracy of the attributes recognized, thereby significantly enhancing the efficacy of the overall video optimization system.

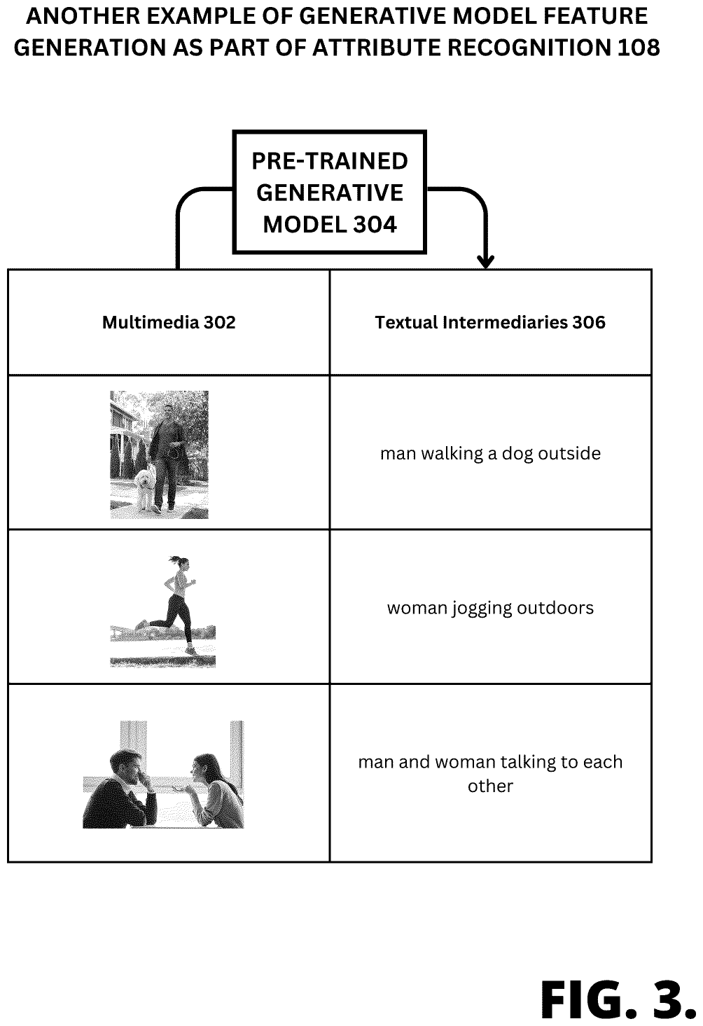

FIG. 3 illustrates an alternative method for generating features within the attribute recognition 108. Unlike the visual question answering method, this approach utilizes image captioning techniques or a broader prompt, such as “What is occurring in this video or image?”

The depicted process in FIG. 3 begins with multimedia content 302. Multimedia content 302 is the same as Multimedia content 202 in FIG. 2. These multimedia elements are fed into a pre-trained generative model 304. This can be done either in a sequential manner or in parallel. The generative model 304 processes these inputs and produces textual intermediaries 306, as depicted in the second column of the table in FIG. 2.

These textual intermediaries 306 are essentially descriptive outputs generated by the pre-trained generative model 304. They provide a textual interpretation of what the model perceives to be occurring in the audio-visual elements received from multimedia 302. For instance, when the first element of multimedia 302, showing a man walking outside with a white dog, is input into the pre-trained generative model 304, the resultant output might be a phrase such as “man walking a dog outside.” This output is then recorded in the textual intermediaries 306.

This approach, showcased in FIG. 3, exemplifies how the generative model can be utilized to extract descriptive attributes from multimedia content, thereby contributing to the broader goal of attribute recognition 108. By converting audio-visual inputs into descriptive text, the system enhances its capability to analyze and categorize multimedia content effectively.

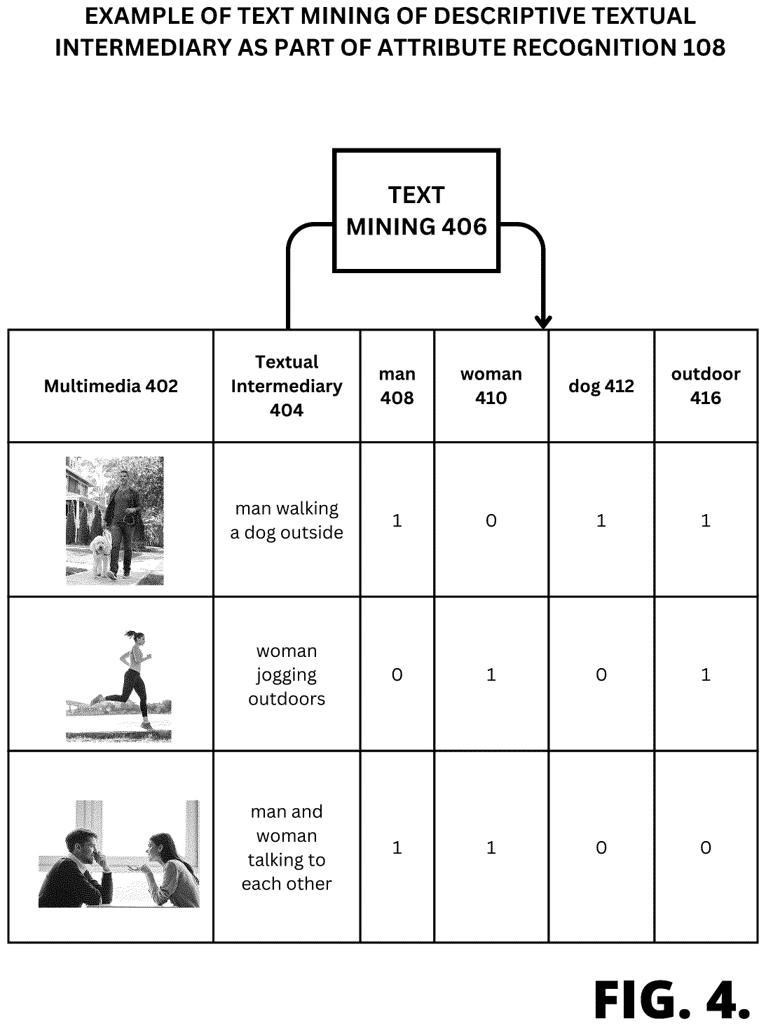

Referring now to FIG. 4, this figure demonstrates the process of further processing a textual intermediary using established text mining techniques.

In FIG. 4, multimedia 402, which corresponds to the multimedia 302 in FIG. 3 and multimedia 202 of FIG. 2, is utilized to generate a textual intermediary, denoted as 404, via the process depicted in FIG. 3. Textual intermediary 404 may then be subjected to further processing and refinement through traditional text mining methods, represented by text mining 406. Examples of methods comprising Text Mining 406 are corpus creation, tokenization, one-hot encoding, and the generation of one or more term-document matrices. Text mining 406 is employed to extract and encode valuable information from the textual intermediary 404, transforming it into a format that is more conducive to subsequent processing and analysis.

For instance, textual intermediary 404, containing the phrase “man walking a dog outside,” is input into the text mining process 406. This process involves the extraction and encoding of key information from the textual content. The extracted data is then represented in various columns such as Man 408, Woman 410, Dog 412, and Outdoor 416. In this specific example, the phrase in the first element of column textual intermediary 404 suggests the presence of a man, a dog, and an outdoor setting. Consequently, the text mining process 406 outputs a value of 1 for the column Man 408, a value of 0 for Woman 410, a value of 1 for Dog 412, and a value of 1 for Outdoor 416. These outputs provide binary indicators for the presence or absence of the mentioned elements.

Similar to the processes illustrated in FIG. 2 and FIG. 3, this text mining procedure is repeated either sequentially or in parallel for additional elements of textual intermediary 404. This methodology ensures a systematic and efficient approach to attribute recognition, transforming unstructured textual data into structured, analyzable formats that significantly contribute to the overall functionality and efficacy of the video optimization system.

The attribute recognition methodologies showcased in FIGS. 2, 3, and 4, while distinct in their approaches, are not inherently exclusive to one another. It's important to recognize that these methods can be employed concurrently within the same analytical framework.

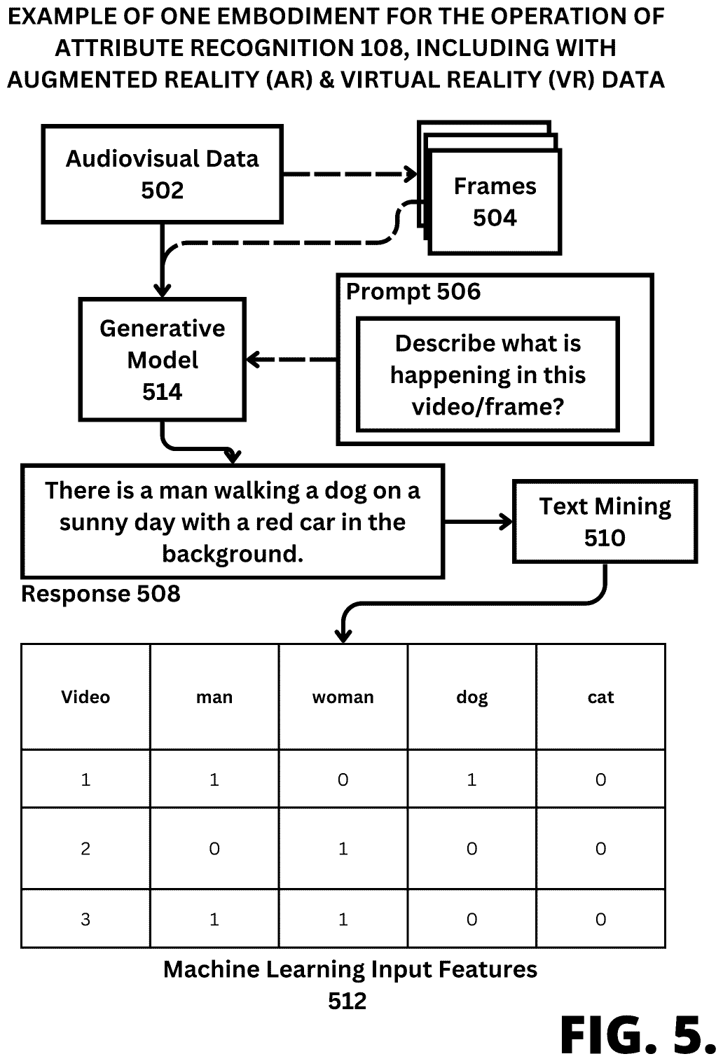

FIG. 5 presents an embodiment illustrating the operation of attribute recognition 108, showcasing an integration of processes depicted in FIG. 2, FIG. 3, and FIG. 4. This figure demonstrates how audiovisual data, as referenced in multimedia 202 of FIG. 2, multimedia 303 of FIG. 3, and multimedia 402 of FIG. 4, is utilized as input for a generative model, denoted as 514. The generative model 514 is designed to describe elements within the audiovisual data 502 and can encompass various AI model forms, including a visual question answering model as seen in FIG. 2 (VQA Model 212), a captioning model as shown in FIG. 3 (Pre-Trained Generative Model 304), or any AI model capable of outputting descriptive elements of audiovisual data. In some embodiments, Generative model 514 takes the form of a Large Language Model (LLM) pre-trained on large volumes of public data.

In this embodiment, audiovisual data 502 can be segmented into frames 504, representing specific time snapshots of the data. The logic for selecting these frames can vary, such as choosing the first, middle, and last frames, a random sampling of n frames from the audiovisual data 502, or any other method for creating subsets of the data. Any or all of these frames 504, as well as the complete audiovisual data 502, may be input into the generative model 514, possibly accompanied by one or multiple prompts 506. An example of such a prompt might be, “Describe what is happening in this video/frame?”

The response to this input from the generative model 514, depicted as response 508 in the figure, could be a descriptive statement like, “There is a man walking a dog on a sunny day with a red car in the background.” Response 508 can then be further processed using text mining, as illustrated in FIG. 4 and denoted in FIG. 5 as text mining 510. The results from text mining 510, along with identifiers of the source input, may then be stored in one or more data tables, as shown in FIG. 5 as table Machine Learning Input Features 512.

In the case of Augmented Reality (AR) and Virtual Reality (VR), the audiovisual data 502 can consist of immersive, three-dimensional content. This 3D data is more complex than traditional 2D video because it includes an additional spatial dimension, offering a depth perspective that is integral to the AR/VR experience. To process this data effectively, we can extend the concept of frames 504 used in traditional 2D audiovisuals.

In AR/VR, frames 504 can be conceptualized as 2D snapshots extracted from the 3D audiovisual content. These frames represent specific moments in time and space within the AR/VR environment. By analyzing these 2D frames sequentially, we can track changes and movements in the 3D space. This process effectively reduces the complexity of the 3D data, making it more manageable for the generative model 514.

For instance, in a VR scenario depicting a person walking through a virtual city, each frame could capture a 2D representation of the scene from a specific point in time. By examining the differences between successive frames, the generative model 514 can deduce the person's path, the movement of other entities, and changes in the environment. This approach allows for the dynamic interpretation of what is happening within the 3D realm.

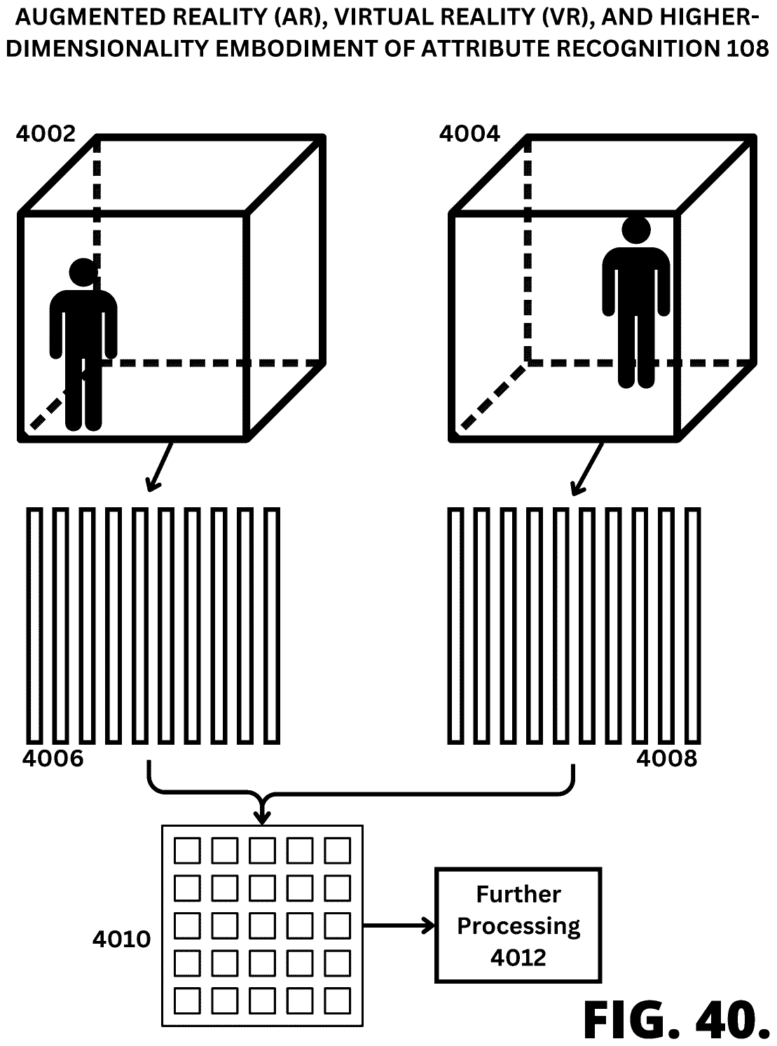

Furthermore, this concept of dimensionality slices can be scaled to even higher dimensions. For example, in a hypothetical 5th-dimension VR experience, the data can first be sliced into 4-dimensional frames. These 4D frames can then be further reduced into 3D frames, and subsequently into 2D frames, each step simplifying the data for more effective processing by the generative model 514. This multi-step reduction approach allows the system to handle extremely complex, multi-dimensional data by breaking it down into more manageable, lower-dimensional snapshots. This processing of higher-dimensionality audiovisual data will be further discussed on FIG. 40.

This process exemplifies a comprehensive approach to attribute recognition, leveraging the capabilities of various AI models and text mining techniques to dissect and interpret the contents of audiovisual data effectively. By combining these methods, the system is equipped to produce detailed and actionable insights from complex multimedia sources, thereby enhancing the overall video optimization process.

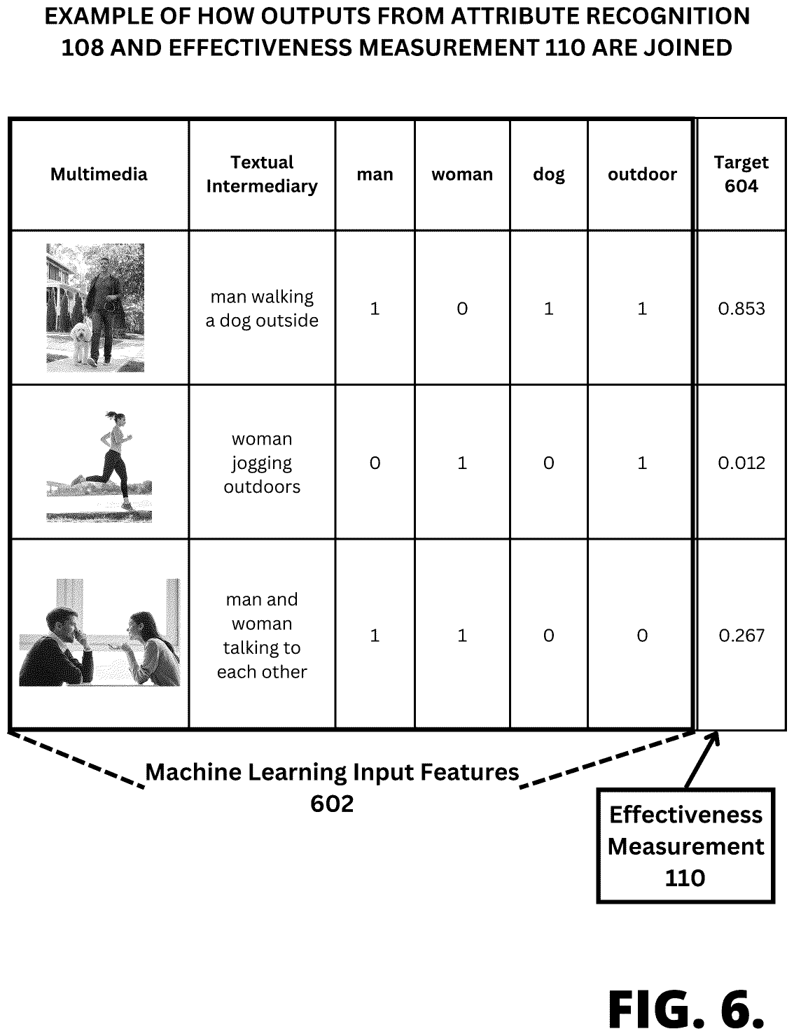

FIG. 6 illustrates a crucial aspect of the video optimization system, emphasizing the integration of outputs from attribute recognition 108 and effectiveness measurement 110 as depicted in FIG. 1. FIG. 6 is pivotal in demonstrating the process by which the output from attribute recognition 108 is synergized with the output from effectiveness measurement 110. Such integration is instrumental for subsequent analysis by pattern recognition 114 of FIG. 1, which is tasked with identifying correlations between various attributes of audiovisual data and multiple performance metrics.

In FIG. 6, a table represented by machine learning input features 602, corresponding to machine learning input features 512 from FIG. 5, includes the crucial addition of target 604. Target 604 embodies one of the outputs from effectiveness measurement 110, as delineated in FIG. 1. Specifically, target 604 in this context represents a normalized inference of downstream incremental revenue performance, scaled between zero and one. Each element within target 604 corresponds to the multimedia element in the same row of machine learning input features 602.

This aggregated table in FIG. 6, encompassing both attribute recognition outputs and effectiveness measurements, serves as a vital input for pattern recognition 114, as depicted in FIG. 1. The process involves the application of pattern recognition 114 on data stored in Data Storage 104 to discern relationships between combinations of audiovisual data attributes, as outputted by Attribute Recognition 108, and various combinations of effectiveness measurements, either directly from Effectiveness Measurement 110 or adjusted by Time Normalization 112. The results of this pattern recognition process are then stored back into Data Storage 104 for further utilization.

Overall, FIG. 6 is a critical representation of how the video optimization system interlinks different components and their outputs to facilitate a deeper and more comprehensive analysis of audiovisual content, ultimately aiding in the optimization of multimedia products.

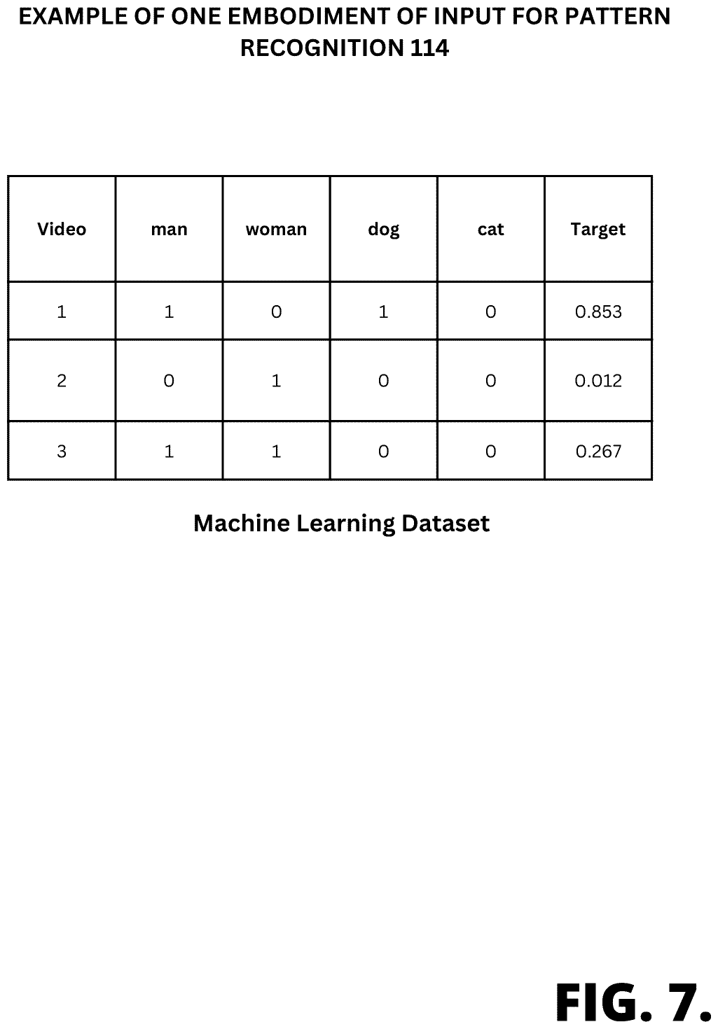

FIGS. 7, 8, and 9 each present different embodiments of input structures for pattern recognition 114, a key component of the video optimization system. These figures collectively highlight the versatility in the types of data that can be fed into pattern recognition 114 for analysis.

In FIG. 7, the input table for pattern recognition 114 is displayed, showcasing a multimedia identifier in the first column. This is followed by four input features, representative of the output from text mining 406 as depicted in FIG. 4. Additionally, a target variable representing the metric of interest for machine learning training is included. This target variable is often referred to as the “dependent variable” in statistical terminology. Subsequent steps of pattern recognition 114 may involve further pre-processing of this dataset, such as removing the identifier or dividing the dataset into various subsets like training, validation, and test sets for machine learning purposes.

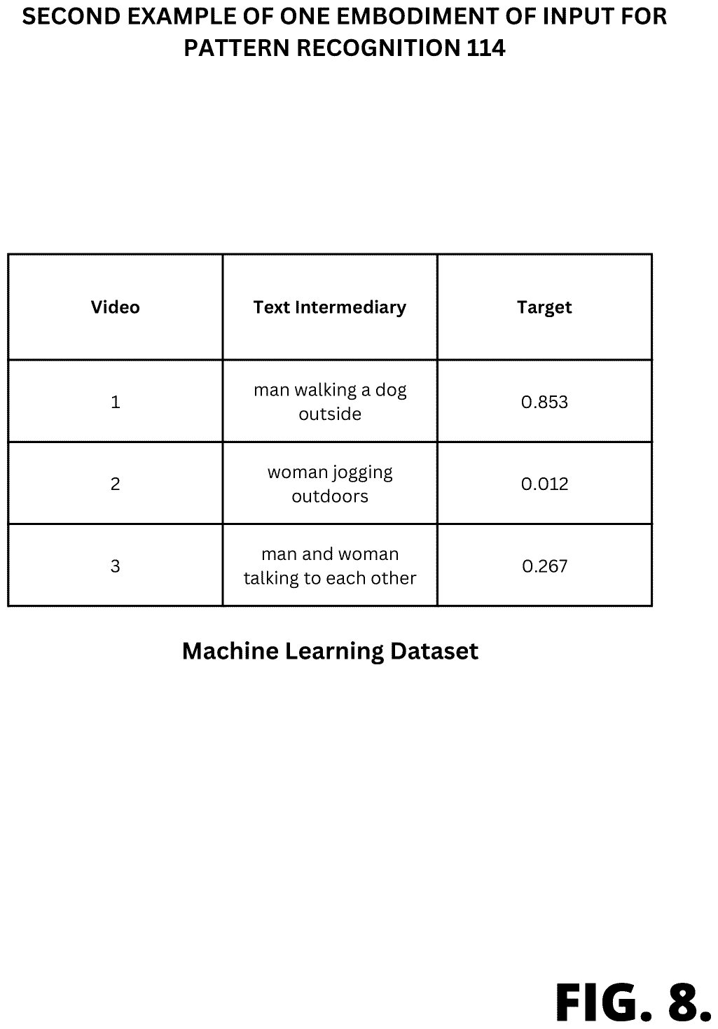

FIG. 8 depicts a machine learning dataset table with a multimedia identifier as the first column, followed by a textual intermediary as a feature in the second column. This textual intermediary is sourced from the method depicted by FIG. 3. A target column, akin to the one in FIG. 7, is also present.

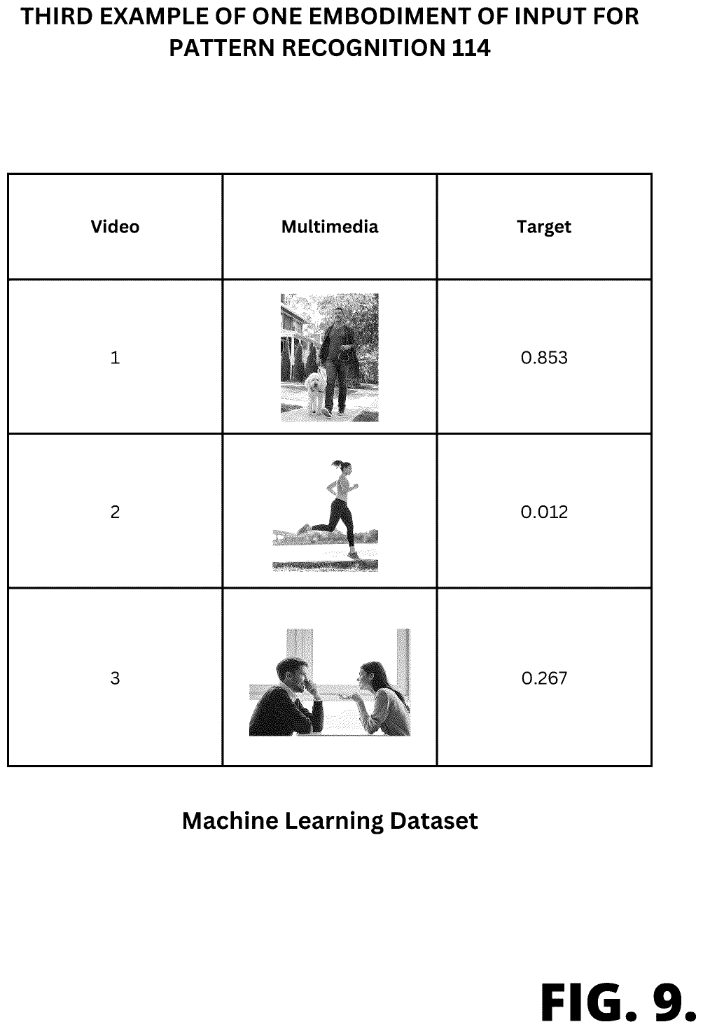

FIG. 9 introduces another embodiment for the machine learning dataset, where multimedia is directly used as an input feature. The identifier and target columns in FIG. 9 are similar to those in FIG. 7 and FIG. 8.

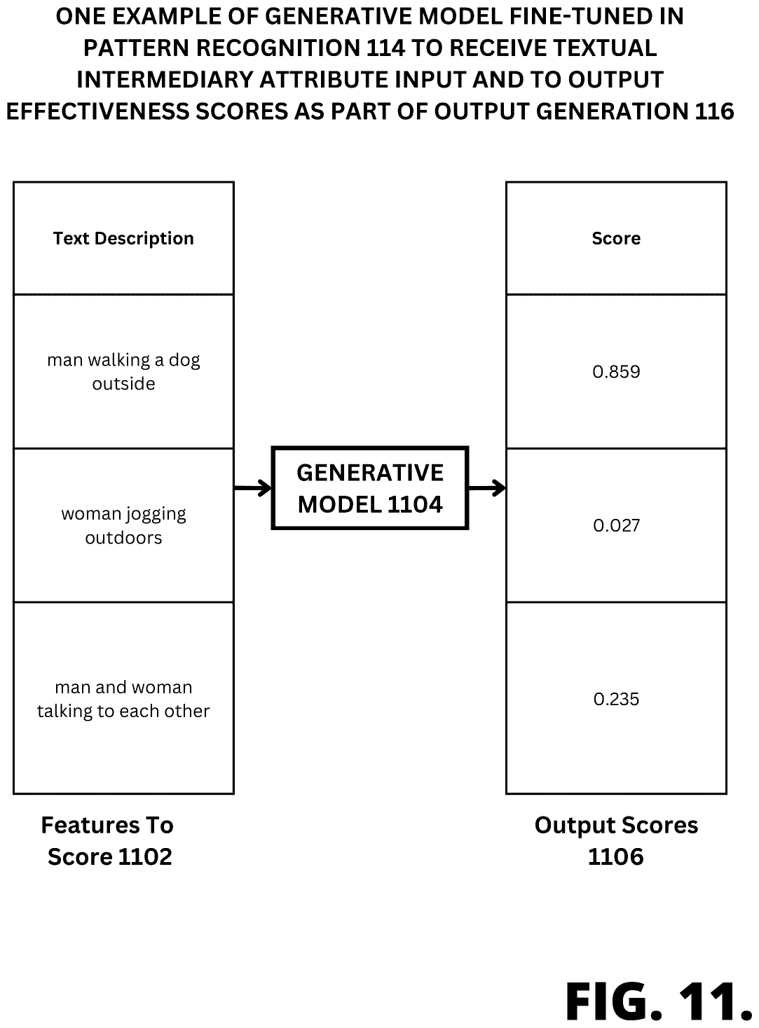

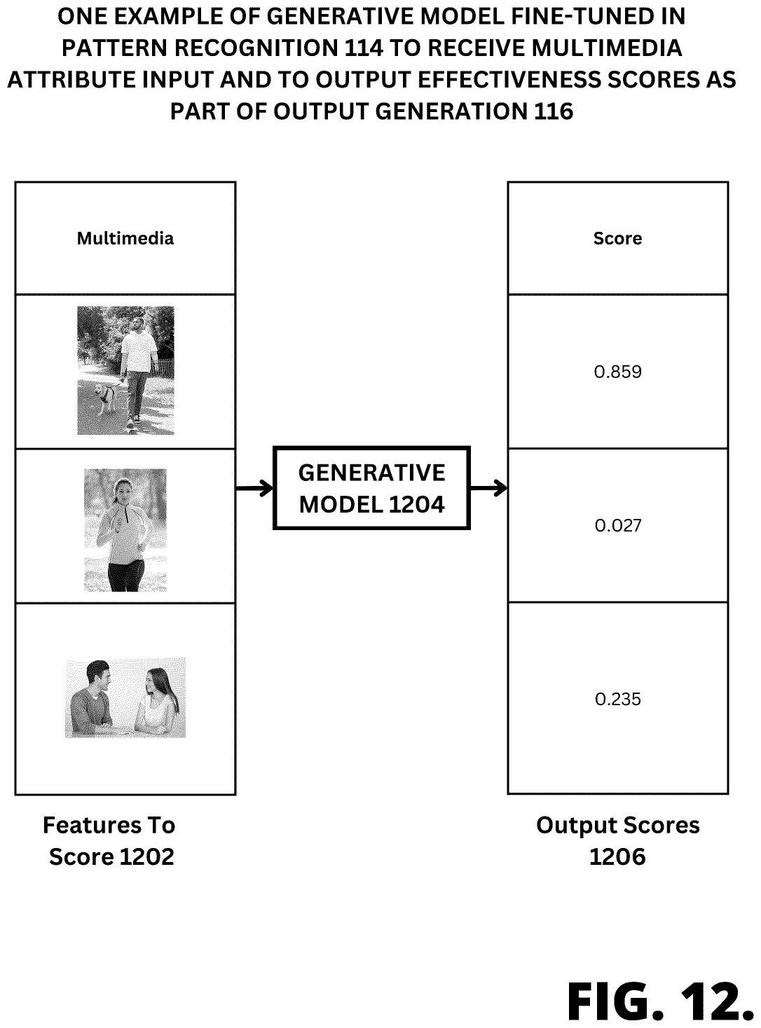

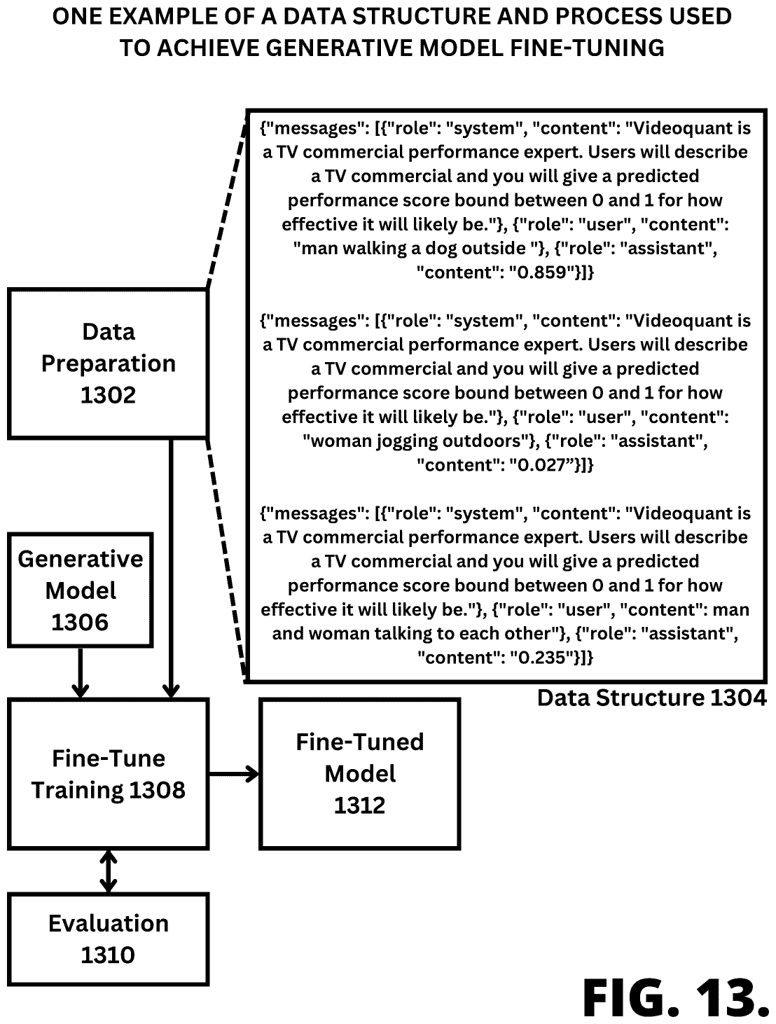

The choice of AI model and architecture for methods of pattern recognition 114 varies depending on the form of the machine learning dataset across FIG. 7 to FIG. 9. For instance, XGBoost or LightGBM are often used when working with datasets like the one depicted in FIG. 7. When dealing with datasets as shown in FIG. 8 and FIG. 9, generative models, such as generative pre-trained transformers (GPTs), are typically utilized. In practice, these generative models are first pre-trained on large volumes of publicly available data, then fine-tuned to output the target as depicted in FIG. 8 and FIG. 9 using a fine-tuning approach depicted in FIG. 11, FIG. 12, and FIG. 13.

Each of FIG. 7 to FIG. 9 demonstrates the adaptability of the system in handling a variety of data formats and structures, thereby enabling a comprehensive and detailed analysis of audiovisual content through pattern recognition 114.

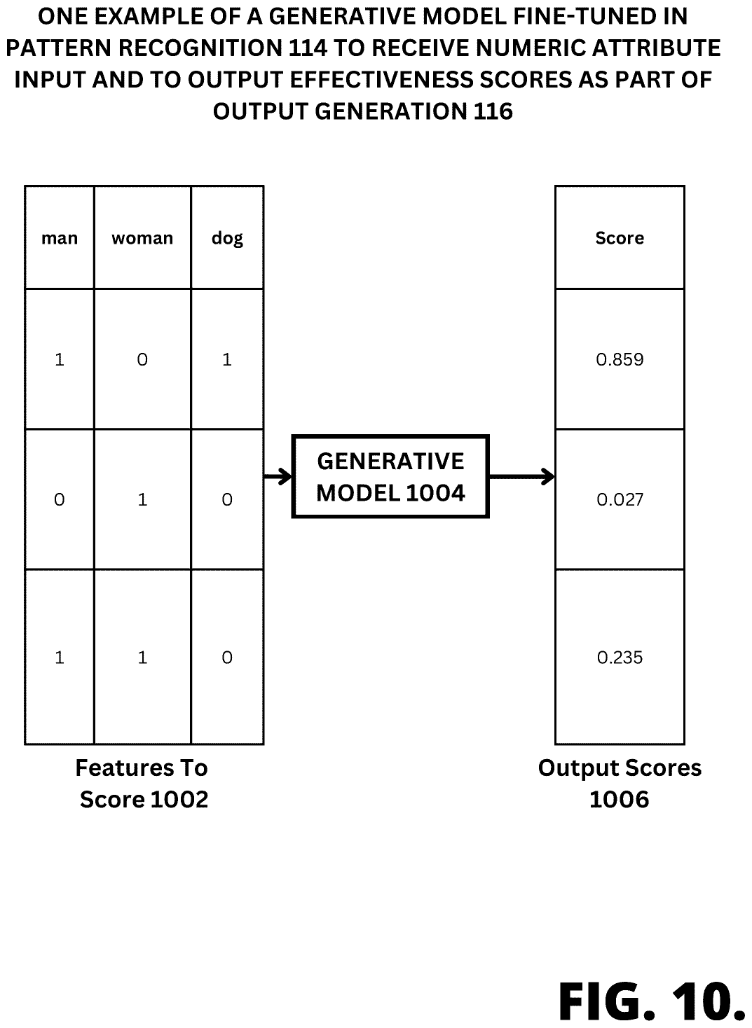

Turning to FIGS. 10, 11, and 12, each demonstrate various embodiments of fine-tuning generative models within the framework of pattern recognition 114, a key aspect of the video optimization system.

FIG. 10 illustrates an example where a generative model is fine-tuned in pattern recognition 114 to receive numeric attribute input and generate effectiveness scores as part of output generation 116. While more traditional machine learning architectures like an XGBoost, LightGBM, or Random Forest may be used to achieve a similar objective, FIG. 10 exemplifies the application of a generative model, such as a Generative Pre-trained Transformer (GPT), which is tailored to process numeric features derived from text mining (as in FIG. 4) and output predictions on the target performance metric, represented here as Output Scores 1006. The higher the score, the more revenue is expected for audiovisual content that aligns with the corresponding row of Features To Score 1002.

In FIG. 11, the generative model is fine-tuned to process textual intermediary attribute input, as derived from a pre-trained generative model of FIG. 3 (textual intermediaries 306). This fine-tuned Generative Model 1104 then generates Output Scores 1106 for new inputs Features To Score 1102, demonstrating the model's capability to interpret and utilize textual data for predictive purposes.

FIG. 12 depicts the use of a fine-tuned Generative Model 1204 to evaluate new multimedia input features represented by Features To Score 1202. The outputs from this scoring are represented by Output Scores 1206, indicative of the model's ability to handle various forms of audiovisual data, such as images, motion pictures, audio, and storyboards, and produce relevant effectiveness predictions.

Importantly, FIG. 13 depicts a specific methodology used for fine-tuning generative models within the system. This figure highlights the use of data structures in the fine-tuning process, particularly focusing on how data from FIG. 8 is transformed into a format suitable for training a Generative Pre-trained Transformer (GPT) or other similar generative models.

In this figure, the data from FIG. 8 is reformatted into JSON messages, depicted as Data Structure 1304, a process executed under Data Preparation 1302. Each JSON message encapsulates the essential elements of the dataset: the input feature and the target value. In the JSON format, the input feature is designated as the content for the role “user”, while the target value is represented as the content for the role “assistant”.

The combination of the data structure 1304 and the pre-trained generative model 1306 becomes the input for the fine-tuning training 1308. During this training phase, the generative model 1306 undergoes additional training using the data encapsulated within data structure 1304. This training aims to enhance the model's ability to generate accurate predictions for the performance target metric, particularly for new inputs that are consistent with the textual intermediaries as shown in FIG. 8.

During and after fine-tuning training 1308, an evaluation process 1310 is employed to assess the accuracy of the fine-tuned model. The core of Evaluation Process 1310 involves assessing the refined model against a test set. This test set comprises data that the model has not encountered during the training phase, thereby providing a realistic scenario to gauge the model's predictive capabilities. The evaluation utilizes a range of appropriate metrics to measure the model's performance. These metrics might include, but are not limited to, mean absolute error, mean squared error, accuracy, precision, recall, F1 score, or any other relevant statistical measure that can objectively assess the model's output quality.

One commonly employed technique in this process is cross-validation. Cross-validation involves dividing the dataset into multiple parts, where each part is used as a test set while the remaining data serve as the training set. This method helps in understanding the model's performance across different subsets of data and ensures that the model is robust and not overly fitted to a specific portion of the data.

In addition to cross-validation, other methods such as bootstrap sampling, leave-one-out cross-validation, or k-fold cross-validation might be used, depending on the nature of the data and the specific requirements of the model evaluation.

The culmination of the fine-tuning training 1308 and evaluation 1310 is a refined Fine-Tuned Model 1312 capable of effective scoring, as depicted by Generative Model 1104 in FIG. 11.

It is crucial to note that while the feature data structure from FIG. 8 is used in the representation of data structure 1304, similar representations can be derived from any or all of the data structures from FIGS. 7 through 9. In scenarios where multimedia input, such as videos, audio, or images, is used, pointers within the JSON messages to these multimedia inputs are commonly incorporated.

This approach illustrates the adaptability and efficacy of generative models in the system, capable of being fine-tuned with various data structures to produce targeted and meaningful output for different types of input features representative of audiovisual content.

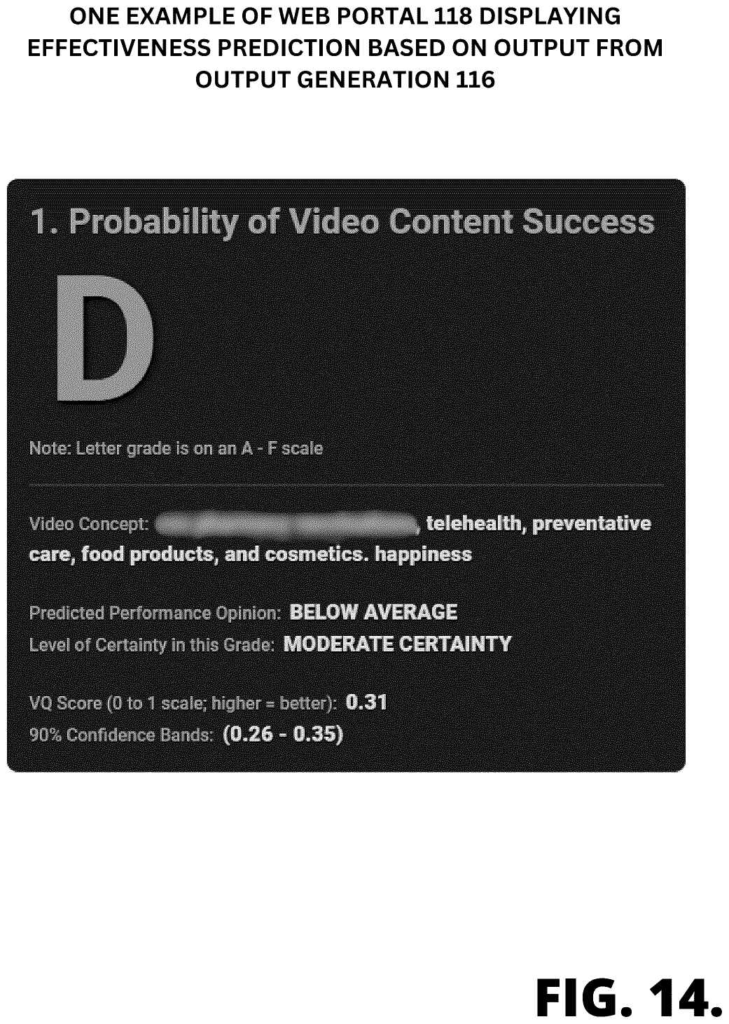

FIG. 14 exemplifies the application of output generation 116 in the context of a web portal interface. This figure is instrumental in illustrating how the system conveys the effectiveness predictions derived from its analytical processes to end-users.

In this specific example, a conceptual idea for a new television commercial is evaluated by the system, and the resulting effectiveness scores are presented through web portal 118. The core element of this output is the “VQ score,” displayed in the penultimate row of the output section in web portal 118. The VQ score is an embodiment of a score depicted in FIG. 10, 11, 12 or from any other model output by Pattern Recognition 114.

The VQ score, which is bounded between zero and one, provides a quantified prediction of the expected incremental revenue from airing a television commercial that aligns with the described audiovisual content. A higher VQ score suggests greater potential for revenue generation, thereby affirming its significance in strategic decision-making.

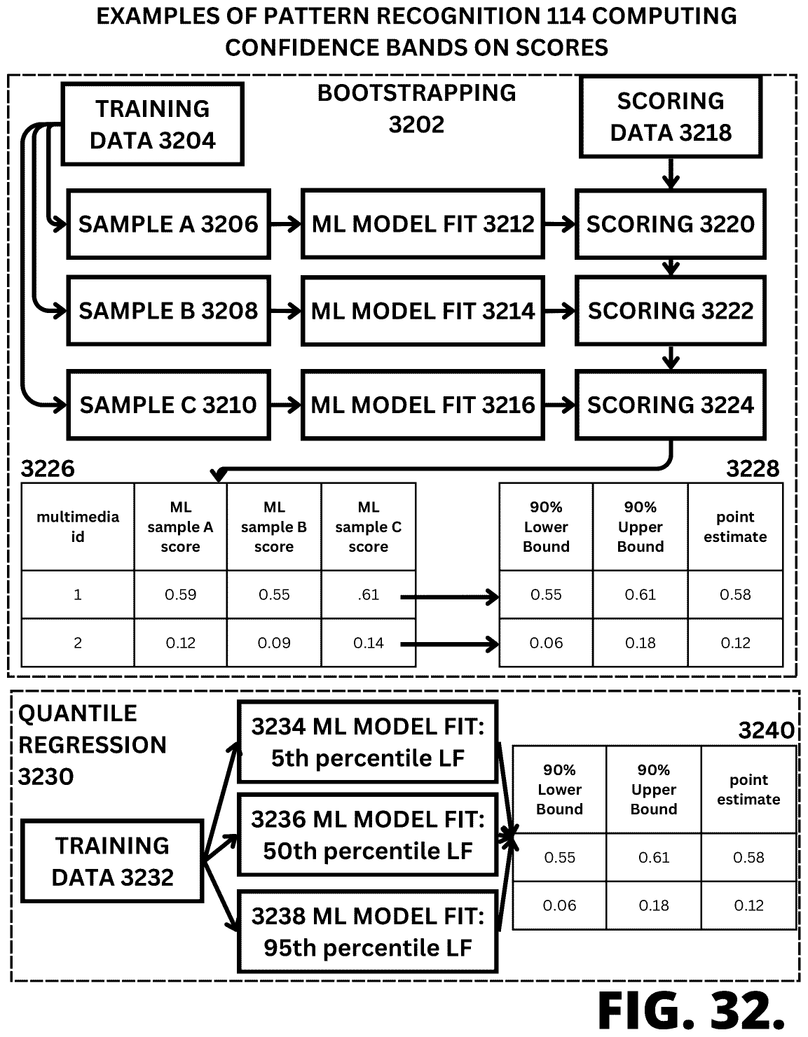

Accompanying the VQ score are confidence spans, calculated by output generation 116 using methods disclosed in FIG. 32. These confidence spans provide an added layer of information, indicating the degree of certainty or reliability of the VQ score. In the depiction within web portal 118, the VQ scores are further categorized into different buckets with labels such as “above average,” “below average,” “excellent,” “fair,” and “poor.” This bucketing and labeling provide an intuitive understanding of the scores and are essential for quick and effective decision-making. The selection of cut-off points for these buckets and the determination of labels are based on extensive data analysis across thousands of brands, providing a data-driven approach to categorizing the scores.

In addition to the VQ score and confidence spans, web portal 118 also assigns a letter grade to the commercial concept, using a similar data-driven approach. In the provided example, the concept is assigned a grade of ‘D’ with a VQ score of 0.31 and confidence bands ranging from 0.26 to 0.35, signifying a certain level of performance expectation.

The confidence bands are also categorized into levels such as “high,” “moderate,” or “low” certainty.

Cut-offs and labels can be stored into Data 104 or in code, and applied to one or more scores as part of Output Generation 116.

The presentation of this data in web portal 118 is crucial for users to understand and interpret the system's predictions and make informed decisions regarding their audiovisual content. It epitomizes the system's ability to translate complex analytical insights into user-friendly, actionable information.

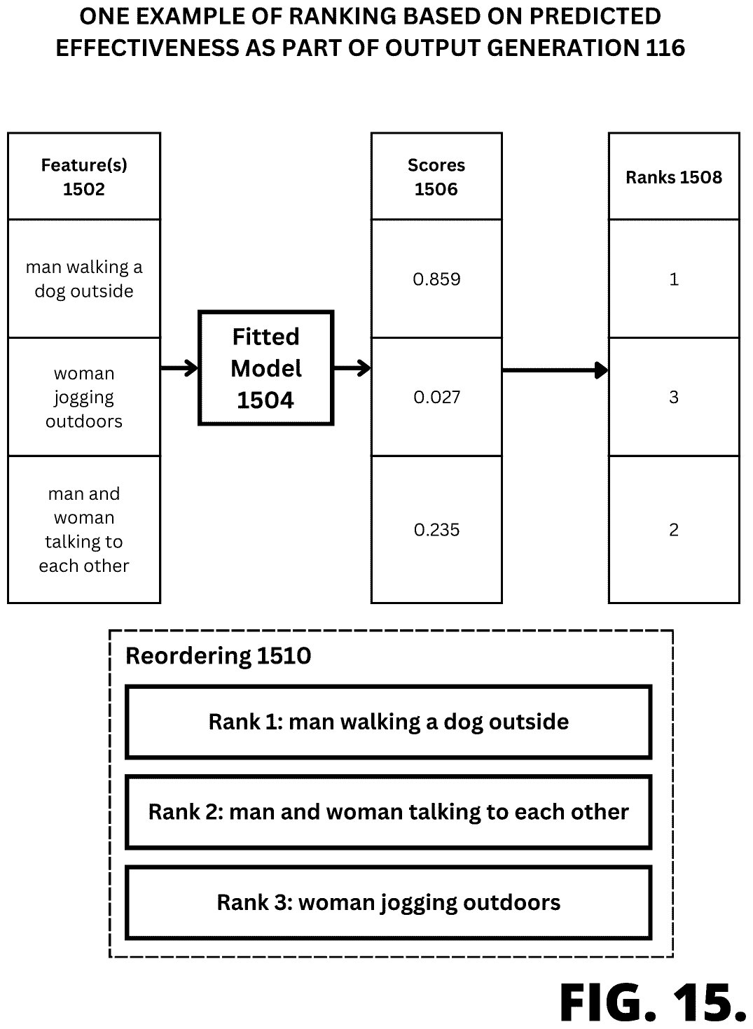

FIG. 15 illustrates an exemplary embodiment of the ranking process based on predicted effectiveness, which is a part of the output generation stage 116 of the system. This figure shares similarities with FIG. 11 in terms of presenting one or more input features to fitted model 1504. The significant distinction in FIG. 15 lies in the depiction of how the output, represented as scores 1506, may undergo ranking, sorting, or reordering processes.

The focal point of FIG. 15 is the mechanism by which scores 1506 are ranked, as depicted by ranks 1508. Subsequent to the ranking process, these scores are then sorted or reordered, as demonstrated by reordering 1510. This reordering process is crucial, as it organizes the output such that the input associated with the highest predicted score is positioned at the top. This is followed by additional inputs, which are methodically arranged in descending order from the highest score to the lowest score.

In practical applications, particularly within the interface of a web portal 118, only a subset of the reordered outputs 1510 is typically displayed to the users. This selective display approach can vary; for instance, it might involve showcasing only the top 10 highest scored entries. Alternatively, the display criteria might be set to include only those entries that surpass a predetermined minimum score threshold. Furthermore, the system offers flexibility in display preferences, such as an option to reorder and subset the outputs in a way that prioritizes the worst predicted inputs, presenting them first.

This ranking and reordering mechanism plays a crucial role in enhancing the user experience by streamlining the presentation of predicted effectiveness, making it more accessible and user-friendly. The system's ability to customize the display of results based on specific thresholds or preferences adds a layer of practicality and efficiency, particularly beneficial for users who seek to quickly identify and focus on top-performing or underperforming inputs in their video content optimization endeavors.

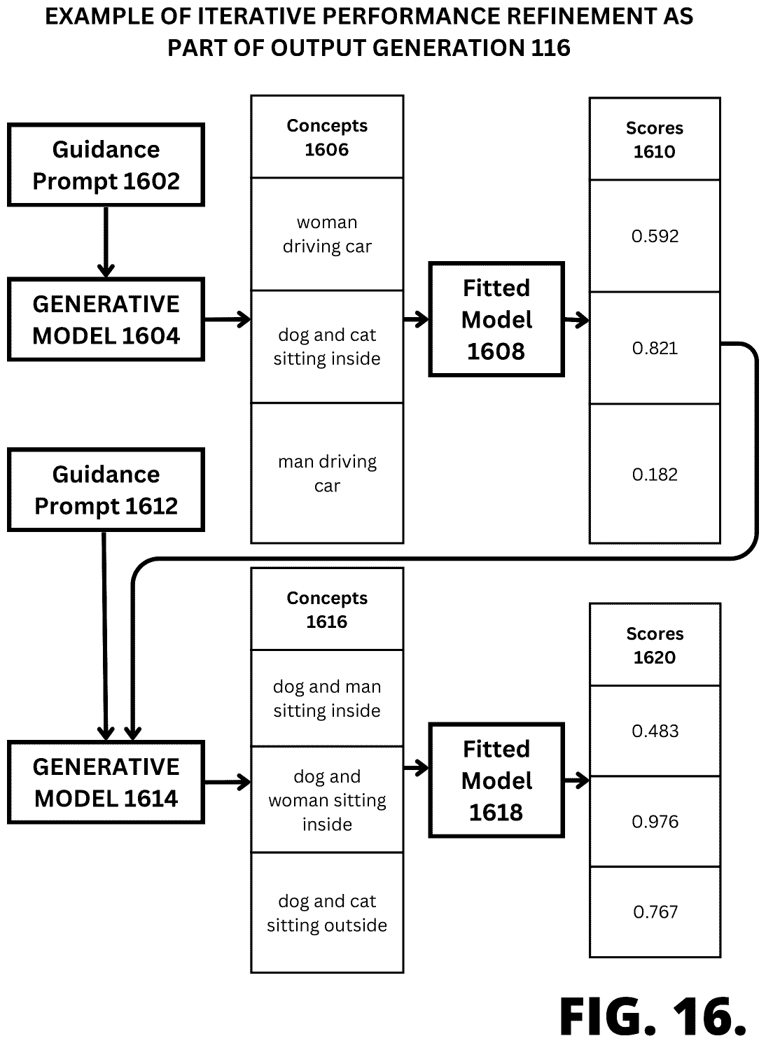

FIG. 16 demonstrates an example of iterative performance refinement as part of output generation 116, showcasing the integration of a generative model with a fitted model to optimize the predictive process. This figure delineates a methodology where a generative model, capable of being trained on extensive public datasets, is employed alongside a fitted model developed from datasets akin to those depicted in FIGS. 7 through 9.

In this embodiment, the generative model's function is to seed new inputs for evaluation by the fitted model. The outcomes from the fitted model can then be utilized as inputs for subsequent iterations of generative models, creating a feedback loop that refines and enhances the predictive accuracy. The process begins with a guidance prompt 1602, inputted into the generative model 1604, which effectively yields a concept 1606. For instance, the generative model 1604 might be a sophisticated language model, and the guidance prompt 1602 could be a request for “10 concepts for a new television commercial”. The resulting concepts 1606 are then fed into the fitted model 1608.

Model 1608, trained on datasets similar to those in FIGS. 7 to 9, may employ various model architectures such as XGBoost, LightGBM, or Random Forest. These architectures are adept at recognizing patterns between input and target variables. The output from fitted model 1608 is represented by scores 1610, which in this example are floating values bounded between zero and one. Higher values within these scores indicate television concepts with a greater predicted return on investment.

While it is feasible to conclude the process at this stage, using scores 1610 as part of output generation, the system allows for further refinement. Scores 1610 can be inputted into a subsequent generative model 1614, along with a new guidance prompt 1612. This iterative process, where the same or a different generative model (like a large language model) is used, is exemplified in FIG. 16. The guidance prompt 1612 in this iteration could be, “Here is a list of television commercial concepts and associated scores; generate new television concepts for me that are predicted to score even higher.”

Leveraging scores 1610 and guidance prompt 1612, the generative model 1614 outputs new concepts 1616. These concepts are then provided as inputs to fitted model 1618, In this case, fitted model 1618 is the same as fitted model 1608 with only the input differing. The output of fitted model 1618 is represented by scores 1620. Notably, the second element of scores 1620 exhibits a higher predicted value than any scores achieved in score 1610, indicating a concept with a potentially higher return on investment. For instance, the concept “dog and woman sitting inside” from concepts 1616 is predicted to perform the best.

In the context of FIG. 16 and its associated iterative performance refinement process, it is important to note that while the example focuses on the use of concepts as inputs for scoring by fitted models, the system is not limited to this type of input alone. As previously discussed and demonstrated with earlier figures, the architecture of the system is versatile and can accommodate a wide range of input formats. This includes, but is not limited to, encoded numeric data, image captioning data, and various forms of multimedia inputs.

The utility of the method disclosed in FIG. 16 lies in its ability to identify and elevate novel concepts that exhibit higher utility than any initial concept provided to fitted model 1608. This iterative refinement process enhances the predictive power of the system, enabling the identification of highly effective concepts for television commercials, thereby optimizing potential returns on investment.

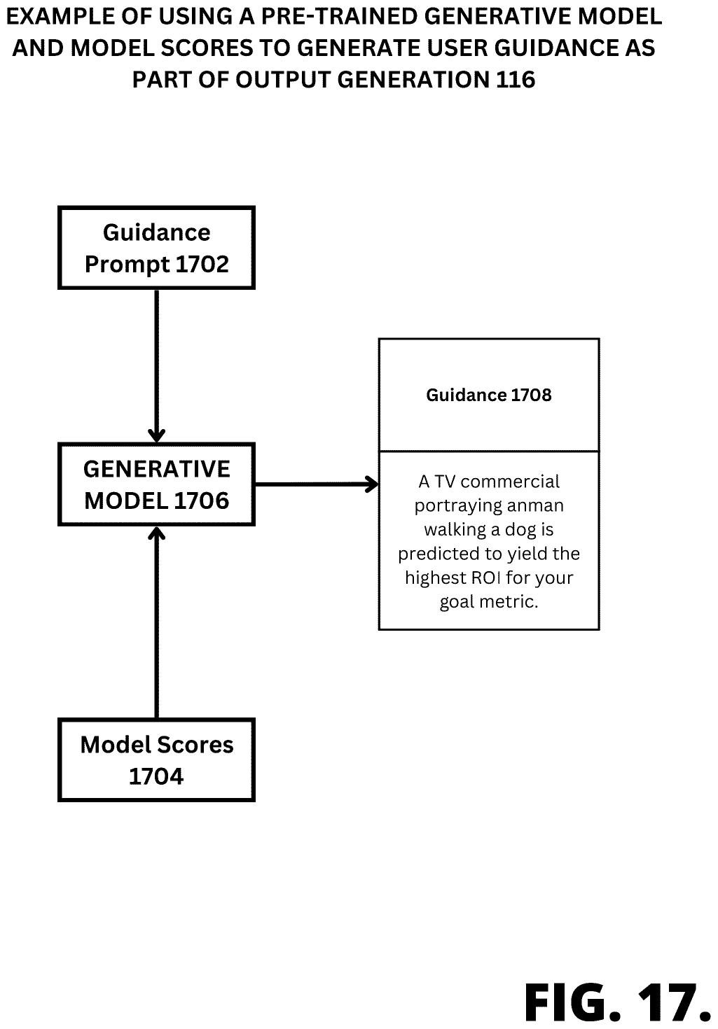

FIGS. 17 through 20 demonstrate the innovative use of pre-trained generative models in conjunction with various input types to generate user output as part of output generation 116. These figures illustrate the system's adaptability and the broad range of inputs that can be effectively utilized to enhance the predictive capabilities of the generative models.

In FIG. 17, the generative model 1706 operates with an input guidance prompt 1702 and model scores 1704. These scores represent outputs from a fitted model trained on data similar to that shown in FIGS. 7 through 9 and related applications. The generative model 1706, which can be a product of fine-tuning processes such as those shown in FIGS. 10 through 13, utilizes the input of model scores 1704 and a descriptive guidance prompt 1702 to produce output guidance 1708. An example of a guidance prompt might be, “using the input model scores and associated audiovisual content, output a descriptive guidance for a new television commercial that is likely to yield the greatest return on investment.” The output guidance 1708, as generated by the model, provides strategic insights for creating effective television commercials.

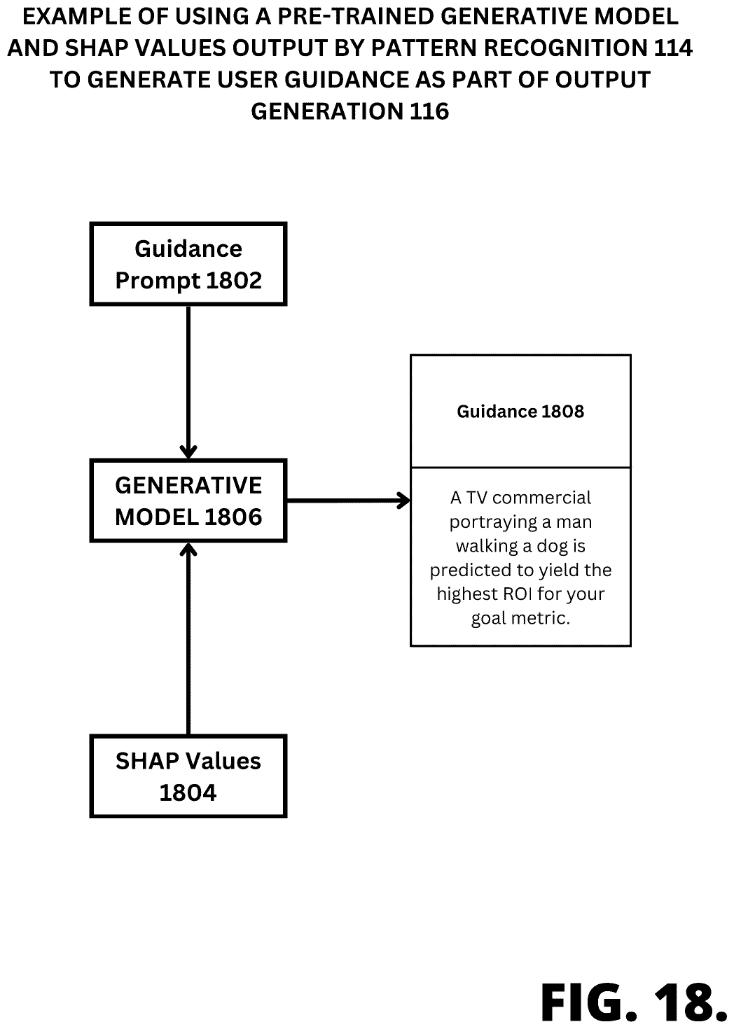

FIG. 18 explores the incorporation of SHAP values 1804 from a fitted model into the generative model 1806, the fitted model having been trained on data similar to that shown in FIGS. 7 through 9 and related applications. SHAP values, based on game theory, assign significance to each feature in a model, indicating their positive or negative impact on predictions. The guidance prompt 1802 in this scenario could be, “Given this dataset of SHAP values associated with television commercial features and their predicted revenue, generate concepts for a new television commercial predicted to yield the highest ROI.” The generative model 1806, using these inputs, produces guidance 1808, offering actionable suggestions for commercial concepts.

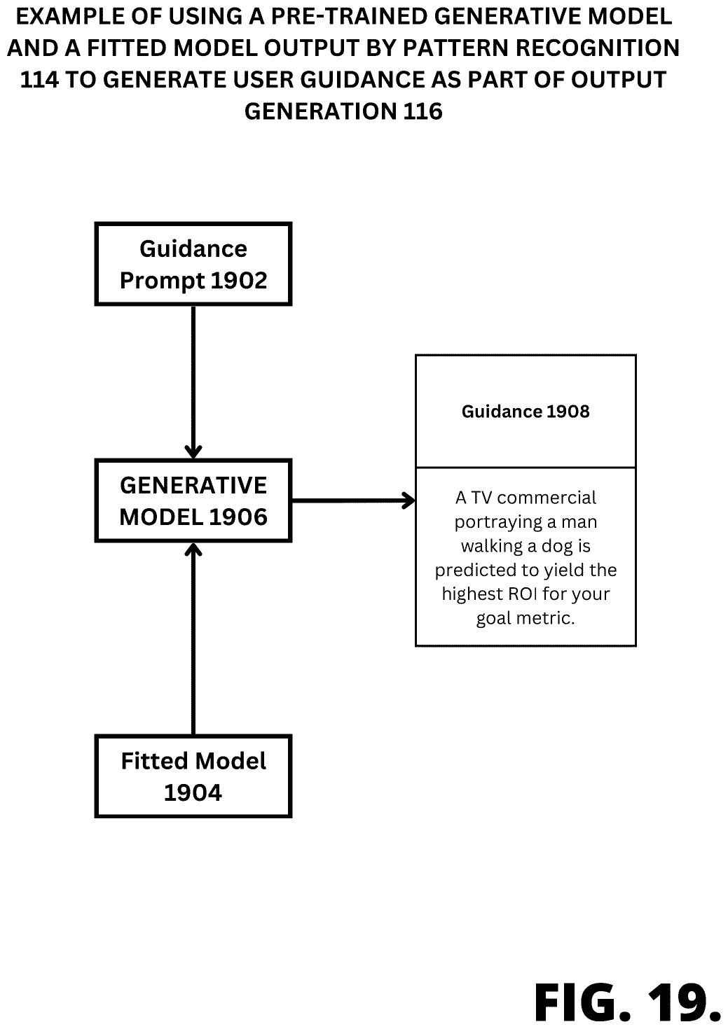

In FIG. 19, the process involves passing a fitted model 1904 itself as an input into the generative model 1906, along with a guidance prompt 1902. An example of such a prompt might be, “For the inputted fitted XGBoost model, generate a television concept that is predicted to yield the highest ROI.” This demonstrates the system's capability to directly utilize the structure and learned patterns of a fitted model to generate highly targeted and effective guidance, as exemplified by output 1908.

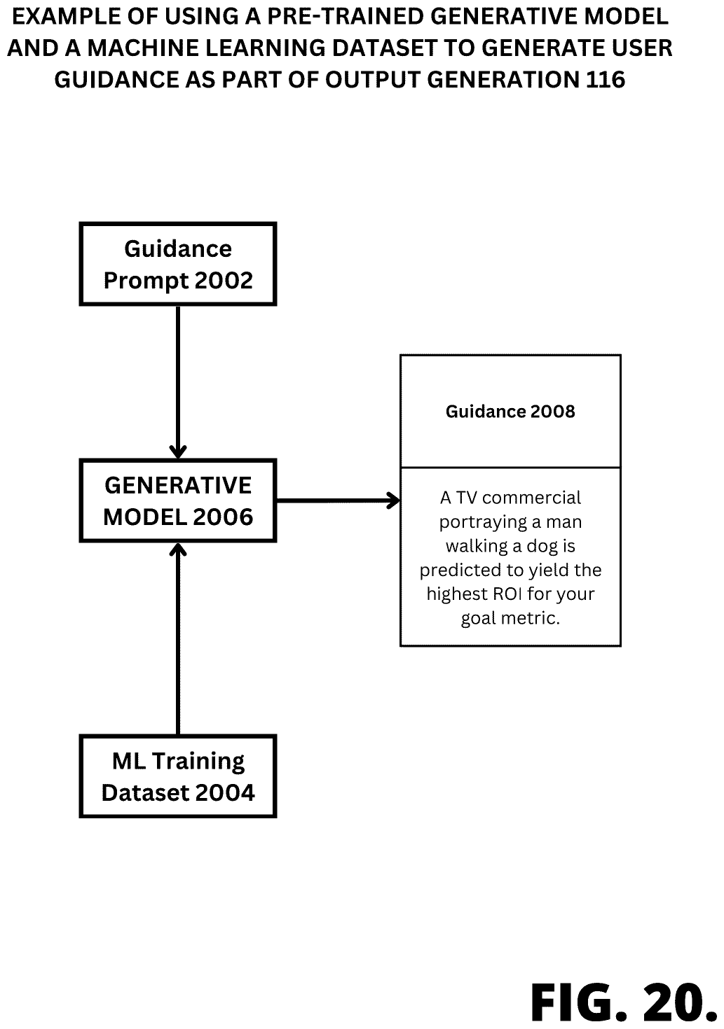

FIG. 20 showcases the use of a machine learning training dataset 2004 as an input to the generative model 2006. This approach illustrates how a separate model fitted on data (as shown in FIGS. 7 through 9) is not necessary; instead, the generative model can directly process the ML training data. The guidance prompt 2002 in this instance could be, “Given a machine learning training dataset with features describing various television commercials and a target variable representing estimated ROI, predict a new television commercial concept likely to achieve the highest target score.” The generative model 2006, using this information, generates guidance 2008, indicating the most promising commercial concepts based on the ML training dataset.

FIGS. 17 through 20 collectively highlight the inventive application of generative models in synthesizing diverse input types for audiovisual optimization—from model scores and SHAP values to the intricacies of fitted models and comprehensive machine learning dataset. This multifaceted approach significantly enhances the system's ability to provide precise, data-driven recommendations for optimizing video content creation and performance.

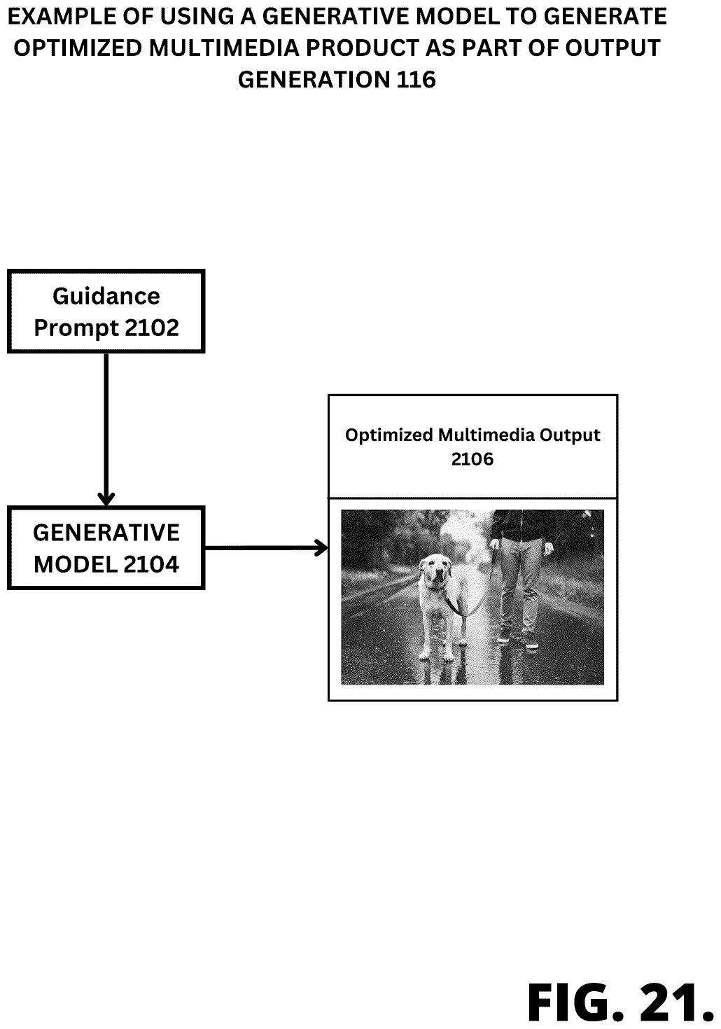

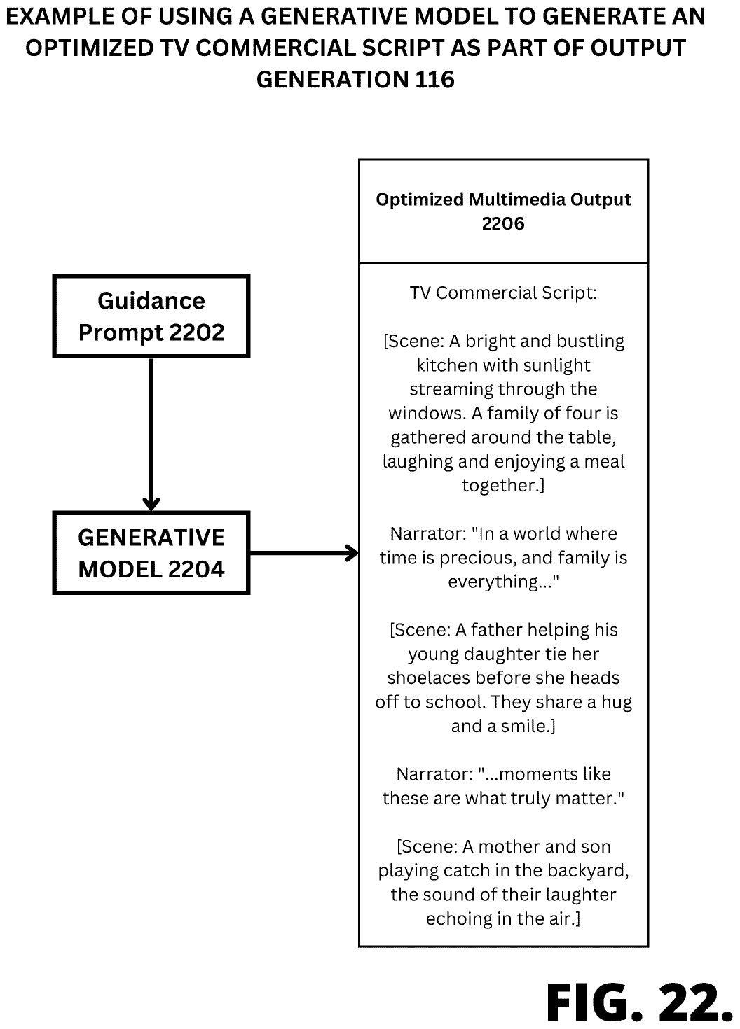

In FIGS. 21 and 22, the invention showcases the application of a generative model in creating optimized multimedia outputs as an integral component of output generation 116. These figures illustrate the system's capacity to generate a diverse range of multimedia products, including but not limited to TV commercial scripts, storyboards, and full multimedia presentations, tailored to maximize return on investment or other desired performance metrics.

FIG. 21 introduces a process where a guidance prompt 2102, such as “generate a 15-second television commercial that is predicted to yield the highest score,” is fed into the generative model 2104. This model may be fine-tuned, similar to the process outlined in FIG. 12, but with a unique adaptation where the content fields contain pointers to multimedia rather than just text descriptions. The output from this process is the optimized multimedia output 2106, which, in this example, is a 15-second TV commercial designed to achieve the highest possible score based on anticipated return on investment or other relevant performance indicators. While the Figure depicts a 15 second TV commercial as the output, this is meant only as an example of the wide array of multimedia outputs possible by implementing the disclosed optimization process, ranging from audio and video to complex storyboards and conceptual presentations.

Moving to FIG. 22, the process involves a similar approach but specifically focuses on generating an optimized TV commercial script. The guidance prompt 2202, such as “generate a 15-second television commercial script predicted to yield the highest score,” is input into the generative model 2204. The model then produces an optimized multimedia output 2206, which, in this case, is a script for a television commercial. This script is devised to align with the highest scoring prediction based on the model's understanding of return on ad spend or other targeted performance metrics. The output, therefore, is not just any commercial script but one that is fine-tuned to meet specific strategic goals, reflecting the sophisticated capabilities of the generative model in processing and interpreting complex input data to produce highly targeted multimedia content.

These examples underscore the innovative use of generative models in the invention, capable of processing diverse inputs and transforming them into optimized multimedia products, yielding a powerful tool for generating strategically-aligned multimedia content with minimal manual intervention.

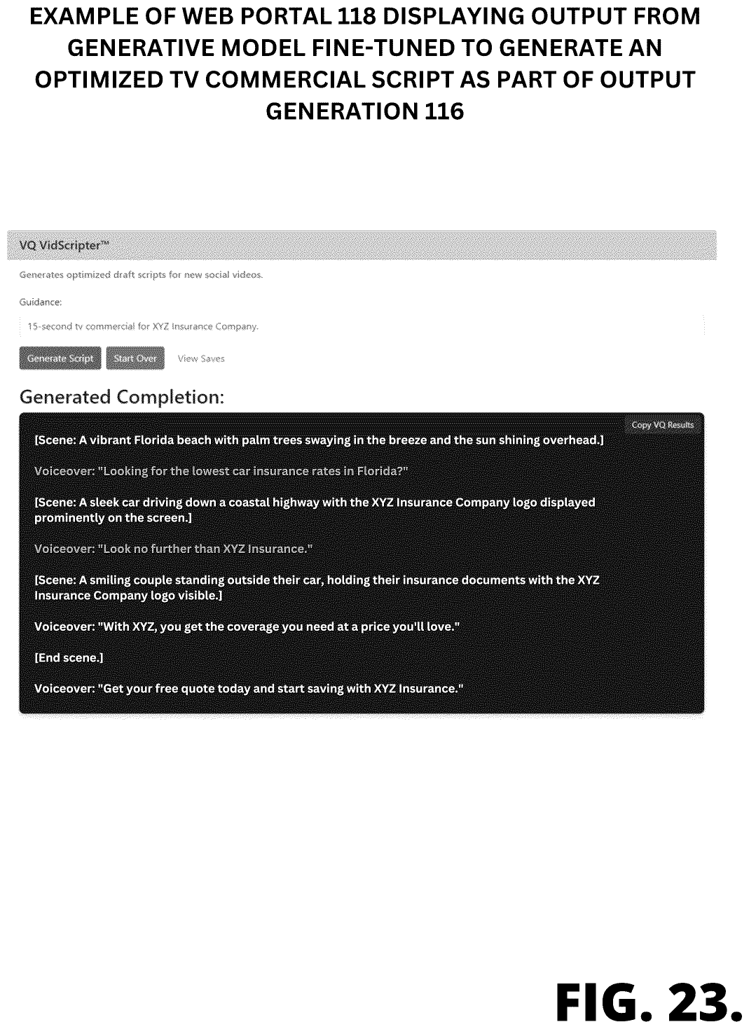

FIGS. 23 through 29 detail various aspects of output generation as rendered by a web portal, emphasizing the application of generative models in producing diverse, optimized multimedia content.

FIG. 23 illustrates how web portal 118 can display output from a generative model that's been fine-tuned to generate optimized TV commercial scripts. In this scenario, the user interface of web portal 118 is designed to accept specific user inputs and display outputs that align with the data processing shown in FIG. 22. For instance, an end user might input guidance like “15 second TV commercial for XYZ insurance company.” The displayed output, set against a text area with a black background, is the result of a generative model similar to generative model 2204 in FIG. 22. This model is adept at generating concepts for TV commercials that are likely to yield the highest return on ad spend, specifically in the automotive insurance space. The output shown here aligns with the optimized multimedia output 2206 from FIG. 22, but is tailored to the user's guidance and the specifics of the insurance-focused fine-tuned generative model.

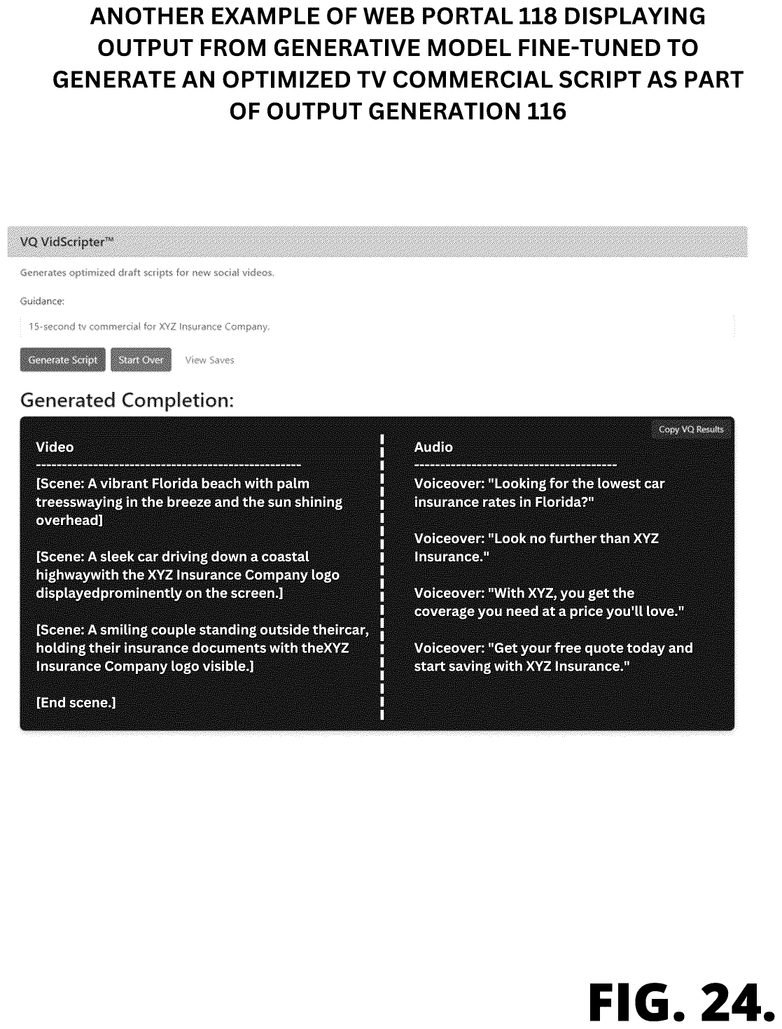

FIG. 24 presents an alternative format for output scripts, similar to those depicted in FIGS. 22 and 23. However, in this instance, the outputs are formatted more traditionally, with video components on the left-hand side and audio components on the right. This illustrates the system's flexibility in presenting information in a user-friendly manner that aligns with industry standards and user preferences.

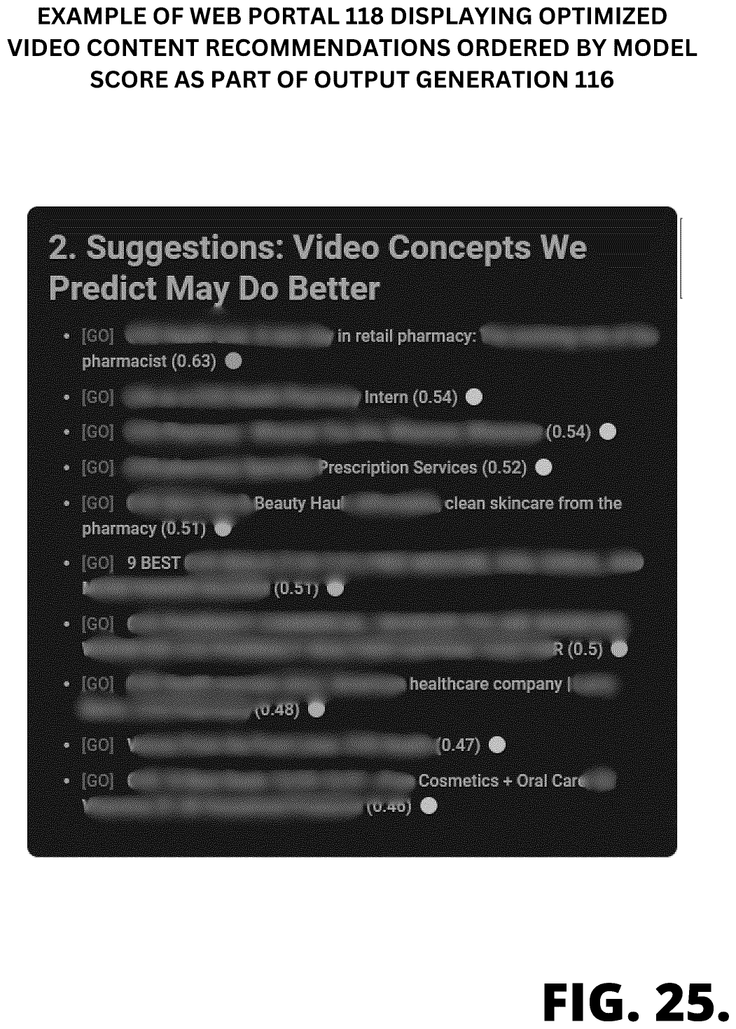

FIG. 25 displays the web portal's capability to present optimized video content recommendations ordered by model scores. This process aligns with the ranking mechanism depicted in FIG. 15, where concepts for new television commercials are generated, likely to perform best based on ROI. An example could include generating concepts for an online retail pharmacy's television commercials, utilizing a process similar to that in FIG. 16.

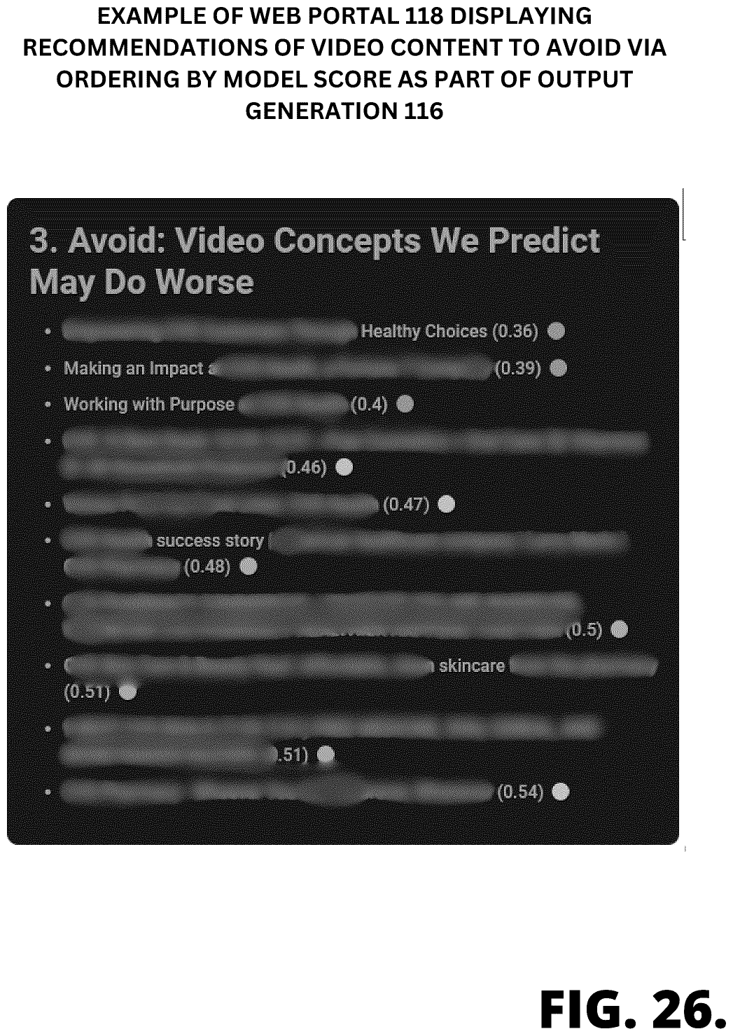

FIG. 26 extends this concept by showcasing video content recommendations to avoid, based on ordering by model scores. The portal displays concepts from lowest predicted ROI to best, focusing on the top 10 with the lowest predicted scores. The scores are presented alongside the concepts, with color-coded dots indicating the extent of effectiveness or lack thereof.

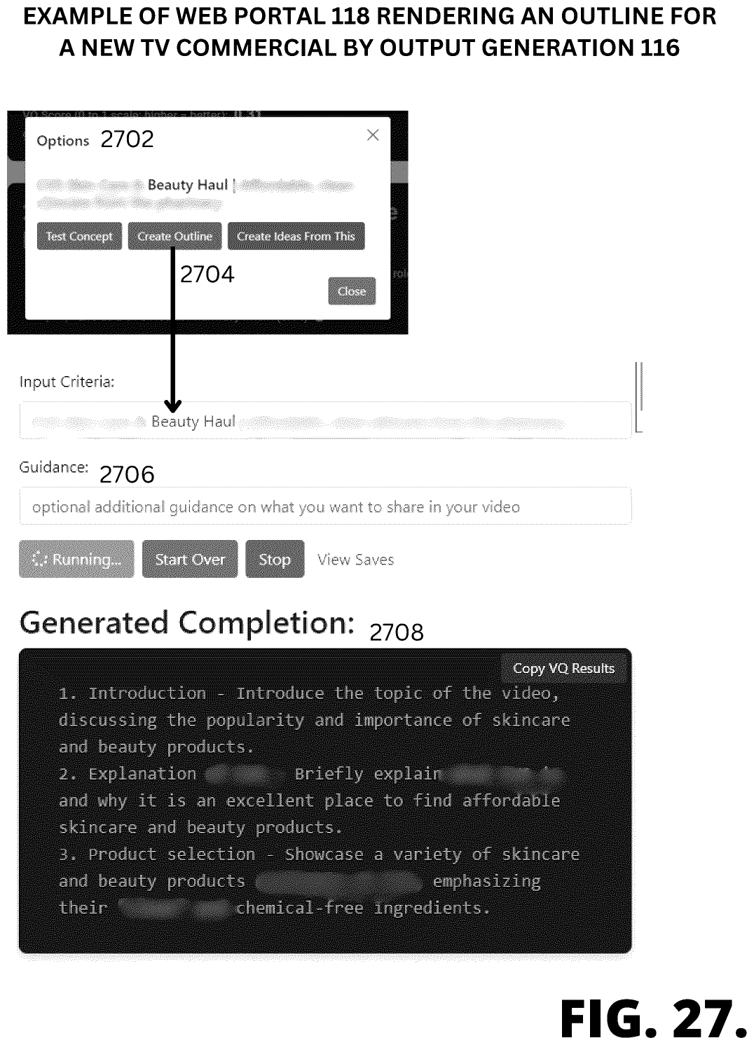

FIG. 27 demonstrates the web portal rendering an outline for a new TV commercial. This is generated by the operation of a generative model within output generation 116. For example, after a user selects a concept they find intriguing, they might click a link to generate an outline for this optimized video topic. The user is then presented with options to input additional guidance, which, along with the selected video concept, is fed into a generative model to create a video outline.

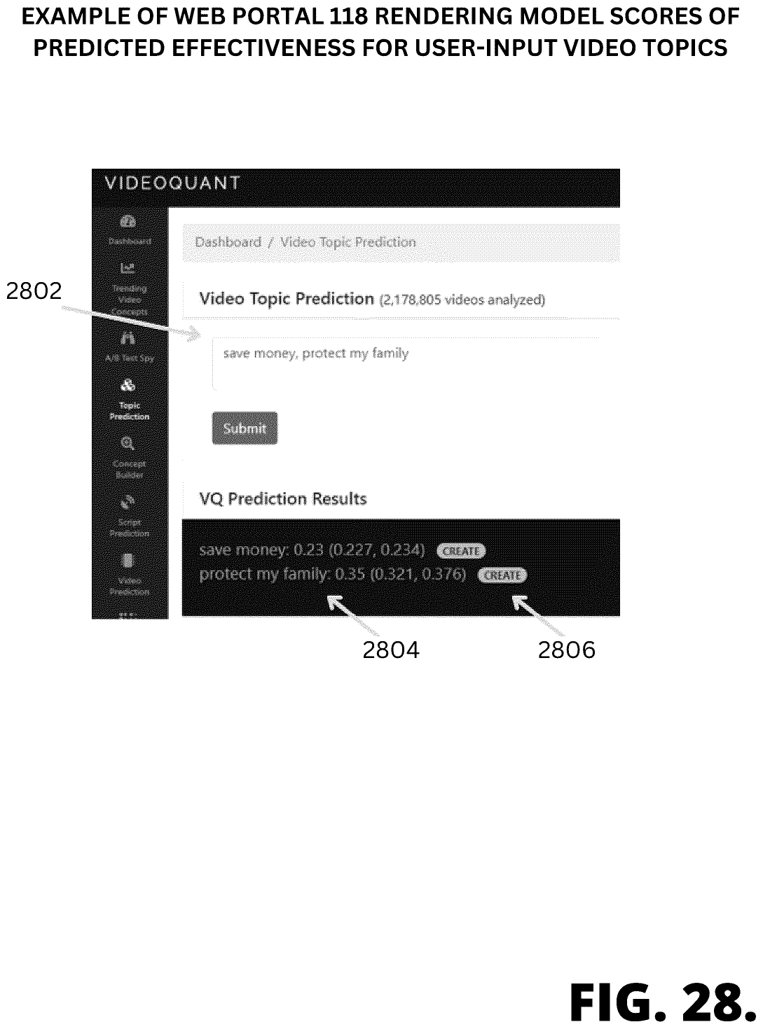

FIG. 28 depicts a user interface within web portal 118 where users can enter various concepts for a new TV commercial. Upon submission, the portal provides scores along with confidence bands for each concept, offering options to create multimedia content aligning with these concepts.

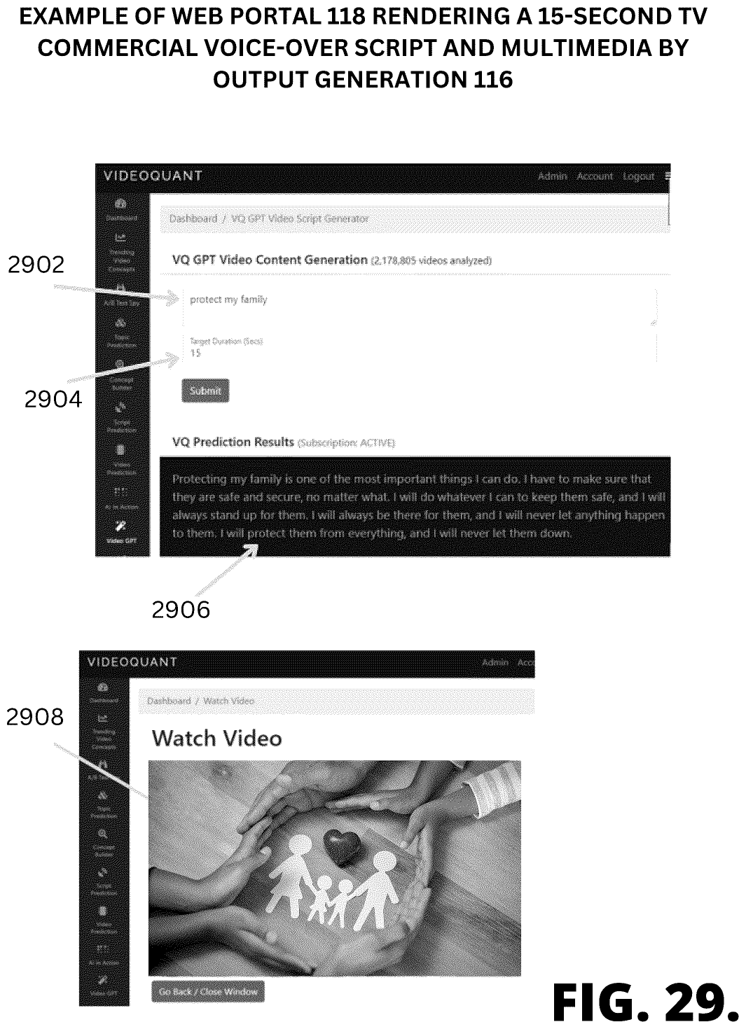

Lastly, FIG. 29 shows the screen following a user's selection of a concept via a create button consistent with the process in FIG. 22. The user inputs like target duration for a TV commercial are provided, and upon submission, the portal displays a script generated for the selected concept. Additionally, a corresponding video may be generated as part of the output, showcasing the portal's ability to render comprehensive multimedia content.

Together, these figures highlight the sophisticated capabilities of the web portal in rendering a variety of outputs generated by generative models. This functionality provides users with a dynamic and interactive platform to visualize and manipulate multimedia content, aligning with specific marketing and advertising objectives.

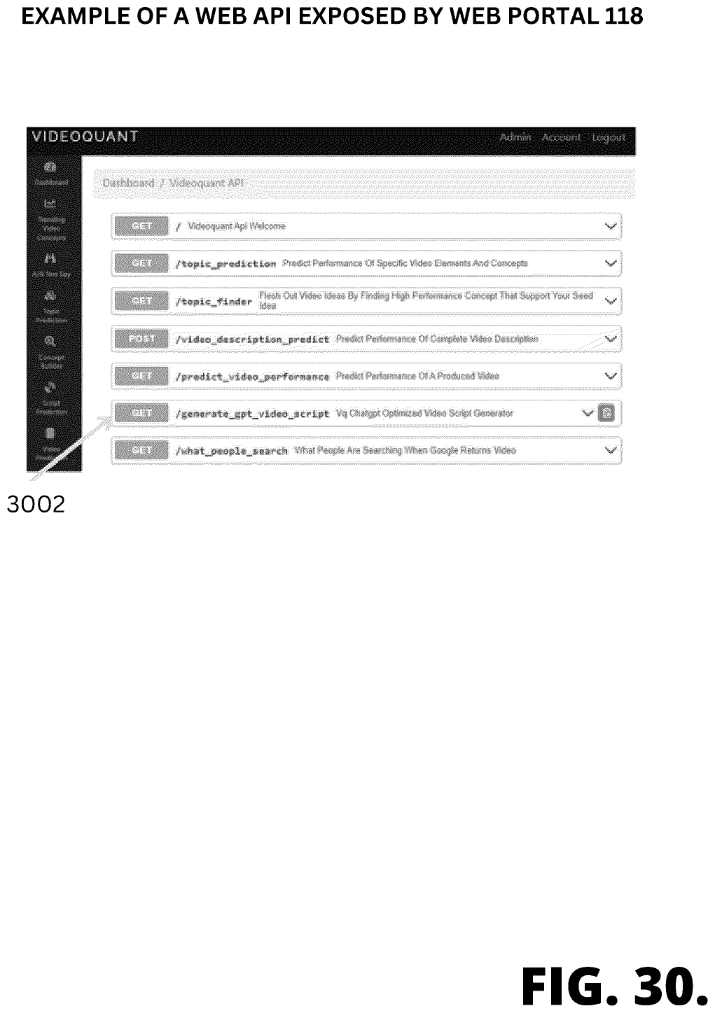

FIG. 30 in the invention showcases the innovative use of a Web API exposed by the web portal 118, demonstrating the integration and practical application of generative models for content creation.

In this example, a GET method 3002 is featured, utilizing a generative pre-trained transformer as the generative model. This model is adept at creating optimized video scripts, aligning with the processes and outputs demonstrated in FIGS. 22, 23, 24, and 29. The API's design and functionality cater specifically to generating content like optimized TV commercial scripts, indicating its role in the broader context of output generation 116 within the system.

The API acts as a bridge between the user inputs, typically provided through the web portal 118, and the generative model's processing capabilities. For instance, when a user inputs a request through the web portal, such as “15 second TV commercial for XYZ insurance company,” the API translates this request into a format that the generative model can process. The generative model, having been fine-tuned to generate high-ROI concepts for TV commercials, particularly in specified domains like automotive insurance, processes the request and generates an output. This output, conforming to the optimized multimedia output 2206 from FIG. 22, is then rendered back to the user via the web portal. Further, the API may be directly exposed to end-users, enabling them to programmatically access the capabilities of the Video Optimization System.

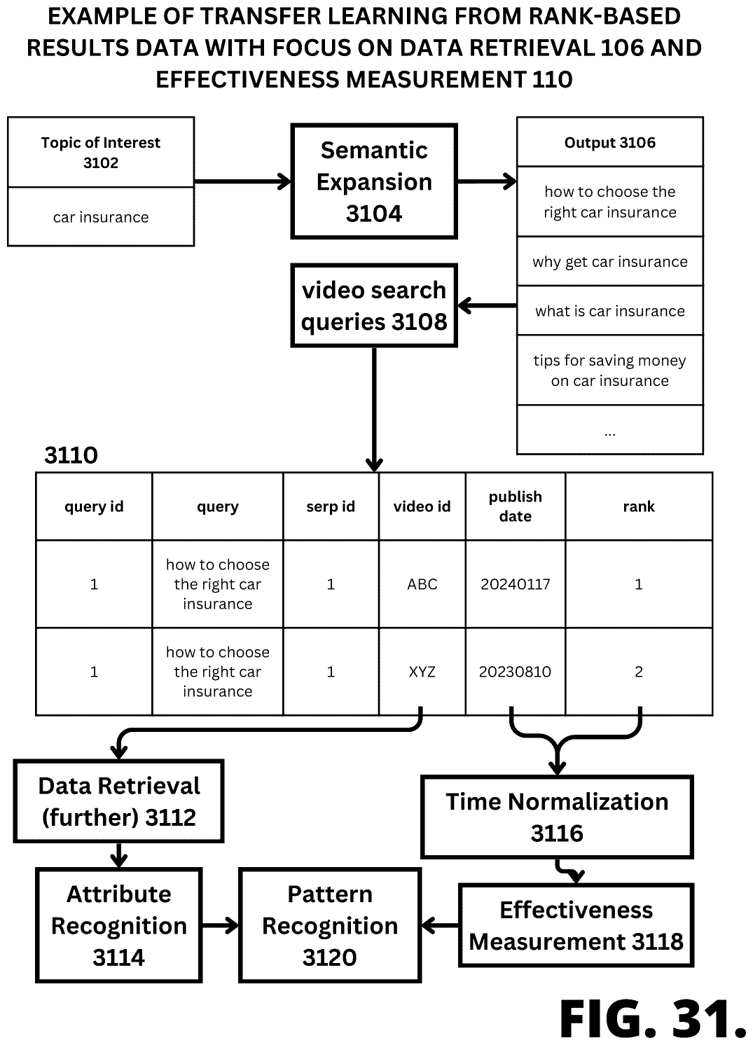

FIG. 31 illustrates an advanced implementation of transfer learning using rank-based results data, focusing specifically on data retrieval (106) and effectiveness measurement (110).

In this figure, the topic of interest 3102, exemplified as “car insurance,” is used as an initial input into a semantic expansion process 3104. This process, semantic expansion 3104, is designed to generate topics associated with the primary input. Various methods can be employed for semantic expansion, including the use of a Large Language Model, generating n-grams from website text related to the topic of interest, querying top online search engine searches associated with the topic, or gathering recommended video titles related to the topic on one or more online video platforms. The output of this semantic expansion is indicated by output 3106, with examples such as “how to choose the right car insurance” and “why get car insurance”.

This output 3106 then seeds video search queries 3108, performed on online video platforms and/or search engines. Each element of output 3106 contributes to building separate queries, which can be executed either sequentially or in parallel. The results of these video search queries 3108 are stored in a table depicted by 3110, with each row representing a single video result on a search engine result page (SERP). For example, the first row could contain a result from the SERP associated with the query “how to choose the right car insurance”. Each query and its associated SERP is assigned an ID, as indicated in the table 3110, along with other details like video ID, publication date, and organic rank on SERP.

It is essential to note that in this example, the ranking is computed exclusively on organic video results, disregarding entries for paid ads, promoted videos, and other snippet data. The entries from table 3110 are then utilized as inputs for further data retrieval 3112 (analogous to data retrieval 106 in FIG. 1). This data retrieval step may involve fetching metadata and audio-visual content associated with video IDs in table 3110.

The retrieved audio-visual metadata and data are then used as input into attribute recognition 3114, which is equivalent to attribute recognition 108 in FIG. 1. Simultaneously, the publication date and rank from table 3110 may be inputs into time normalization 3116 and/or effectiveness measurement 3118. Time normalization 3116 and effectiveness measurement 3118 correspond to time normalization 112 and effectiveness measurement 110 in FIG. 1, respectively. If time normalization 3116 is employed, its output may be used as an input for effectiveness measurement 3118.

Finally, the outputs generated by attribute recognition 3114 and effectiveness measurement 3118 are used as inputs into pattern recognition 3120, which is the same as pattern recognition 114 in FIG. 1. This comprehensive process, as depicted in FIG. 31, effectively demonstrates how the ordering of content within search engine results pages can be leveraged as a target metric for the disclosed video optimization process.

FIG. 32 in the patent application exemplifies the computation of confidence bands and other measures of uncertainty on scores, an aspect of the video optimization system's pattern recognition capability 114.

In FIG. 32, two methodologies are showcased for calculating confidence bands, serving as examples among other potential methods. The top part of the figure, labeled as bootstrapping 3202, illustrates the use of bootstrapping to generate confidence bands. In this process, training data 3204, which aligns with the data structures shown in FIGS. 7 through 9, is sampled multiple times with replacement. These samples, such as sample A 3206, sample B 3208, and sample C 3210, are then used to fit separate machine learning (ML) models, as denoted by ML model fit 3212, 3214, and 3216, each corresponding to their respective input data.

Each of these fitted models scores the data (scoring data 3218), and the scoring outcomes are tabulated in table 3226. For instance, ML model fit 3212 scores the data as part of process scoring 3220, with the results displayed in table 3226. Typically, a range of 100 to 1000 model fits are used, resulting in an equivalent number of columns within table 3226. These outputs are then utilized to compute percentiles and other measures of variance and uncertainty. For example, calculating the 95th and 5th percentiles across columns for each row provides an empirical 90% confidence band for each row on input scoring data. The upper and lower bounds of this band, along with a point estimate (typically the mean or median), are recorded in table 3226.

However, a limitation of the bootstrapping method 3202 is its time-consuming nature, owing to the need for fitting many models. To mitigate this, quantile regression 3230 offers a more efficient alternative. In this approach, training data 3232 (identical to training data 3204) is used to fit three distinct ML models: ML model fit 3234, 3236, and 3238. The loss function for each model is adjusted to yield scores at specific percentiles—the 5th percentile for ML model fit 3234, the 50th percentile for ML model fit 3236, and the 95th percentile for ML model fit 3238. Similar to scoring data 3218, these models are applied to scoring data, leading directly to outputs akin to those in table 3240. The scores from each model are denoted in table 3240 as the 90% lower bound, point estimate, and 90% upper bound, respectively. Table 3240 contains one row for each row of data in the scoring data set.

In summary, FIG. 32 illustrates the system's capability to pre-compute confidence bands on scores, enhancing the reliability and interpretability of the output generated by the video optimization process.

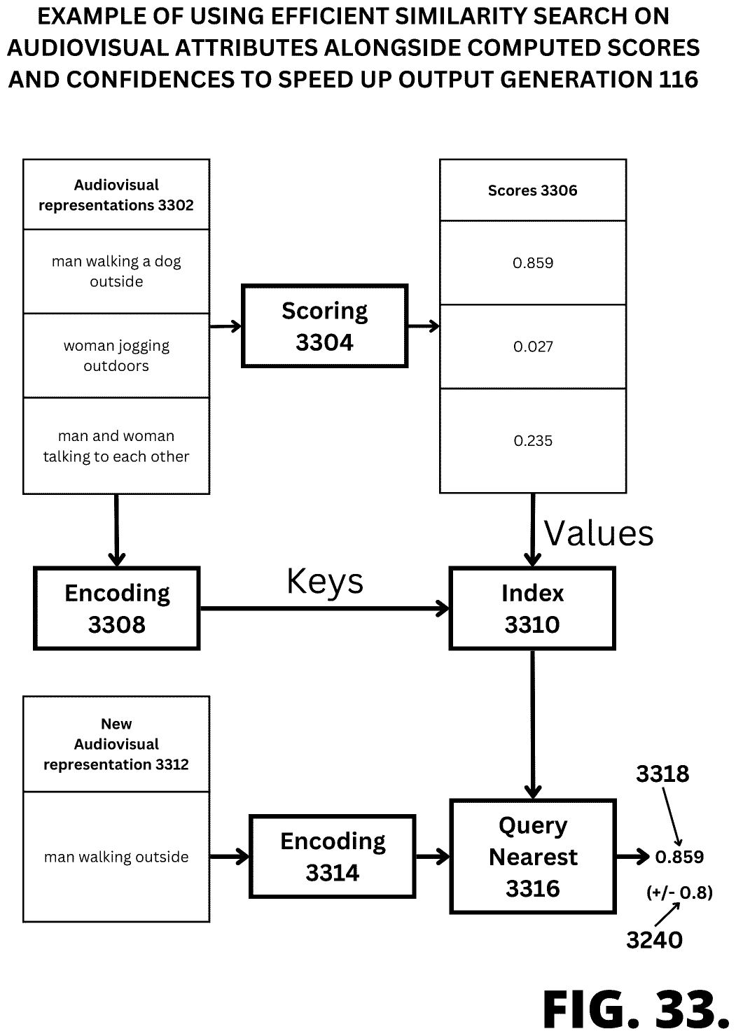

FIG. 33 introduces an example of utilizing efficient similarity search on audio-visual attributes alongside computed scores and confidences to expedite the output generation process, identified as part 116 in the system. This approach is significant as it offers a method to speed up the generation of output without the need for real-time scoring for each input.

In this process, while output generation 116 typically involves scoring data with a fitted model, the system also permits the precomputation of scores on a large volume of input data. This data is then utilized as input to keys for indexing, with the scores and/or variance data serving as values. Such indexing allows for millisecond-level response times for predictions on how new inputs may perform, thus obviating the need for a scoring step in real time.

The audiovisual representations 3302, such as “man walking a dog outside”, are used for scoring 3304, resulting in scores 3306. These representations can be encoded (as shown by encoding 3308) to facilitate efficient indexing and searching. Both the raw representations 3302 and/or the encoding 3308, along with their associated scores 3306, are used to create an Index 3310. Technologies like FAISS may be employed to create this Index, enabling rapid similarity search and dense vector clustering for new audiovisual representations 3312.

For instance, if a new audiovisual representation 3312 is “man walking outside”, this input may undergo encoding 3314 using the same encoding scheme as encoding 3308. This encoding is then searched in Index 3310 (Query Nearest 3316). In most embodiments, the search is fuzzy, meaning that it's expected that the keys will differ from the new input and that we're seeking to identify the closest keys associated with the new input. The output from this query might be the keys and values associated with the nearest audiovisual representations to the new input. For example, the nearest 100 audiovisual representations 3302 might be returned. This output can then be post-processed to yield a point estimate 3318 and a confidence band 3240, using statistical methods such as percentiles and averages.

Confidence bands and other measures of uncertainty can be pre-computed and stored as values, consistent with the methodologies described in FIG. 32, or the results from the similarity search can be used to compute confidence bands, albeit with potentially less accuracy. These methods can also be used in conjunction with each other, providing a versatile and efficient approach to generating and evaluating multimedia content. The system's design thus incorporates both precomputed measures and real-time similarity searches to deliver rapid and accurate predictions for audiovisual content.

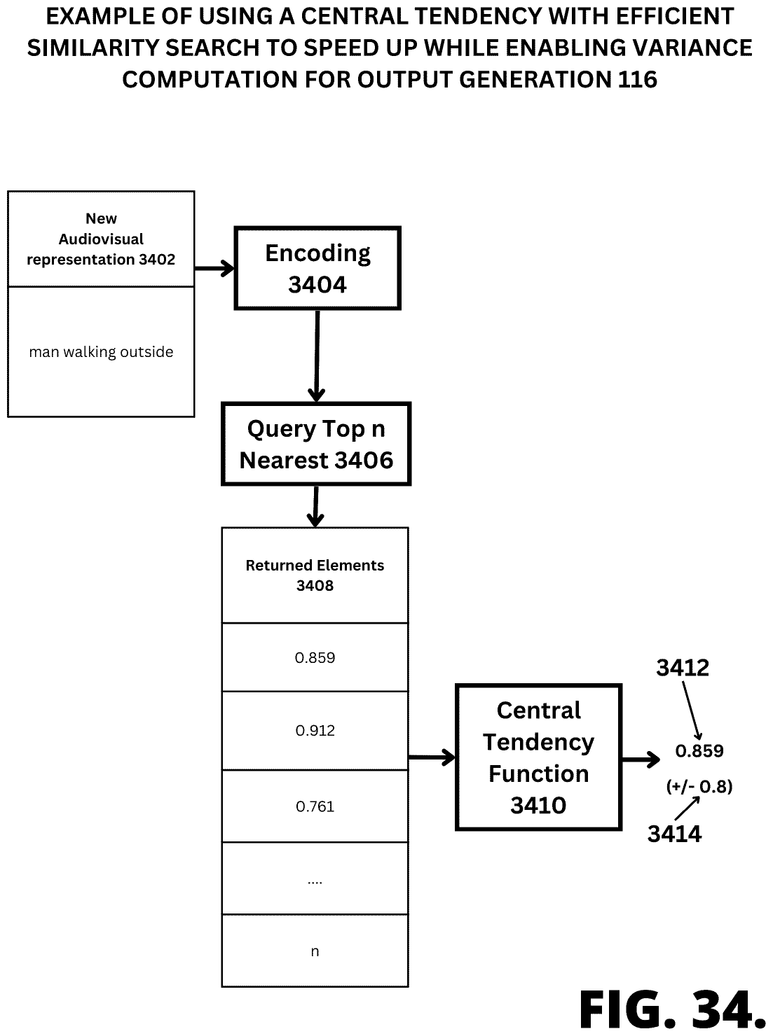

FIG. 34 demonstrates the use of a central tendency in conjunction with efficient similarity search to accelerate and enable variance computation for output generation 116 in the video optimization system. This figure builds upon the processes depicted in FIG. 33, showcasing an advanced method for scoring new data.

In FIG. 34, a new audio-visual representation 3402, exemplified as “man walking outside” 3402, undergoes encoding 3404. The output from this encoding is utilized to query the top ‘n’ nearest elements 3406, such as the top 1000, using a prebuilt index similar to the one depicted in FIG. 33 (Index 3310). The returned elements 3408 may include keys closest to the input query, row identifiers, and associated values. For simplicity, the figure illustrates only the values for the returned elements.

These returned values may then be subjected to post-processing through a central tendency function 3410, which is employed to compute a point estimate 3412 and a confidence band 3414. The central tendency function could utilize various statistical methods, including the use of a student t-test, percentiles, mean, median, or other aggregation functions.

The system's design allows for the encoding step (both in encoding 3404 and 3408) to be flexible. In some instances, encoding could involve generating a textual intermediary to be used as keys for the similarity search. In other cases, the input can be passed directly to the next step without any encoding.

The system's adaptability in handling various encoding schemes, coupled with the efficiency of similarity searching and statistical processing, makes it a robust tool for rapid and accurate audio-visual content evaluation and optimization.

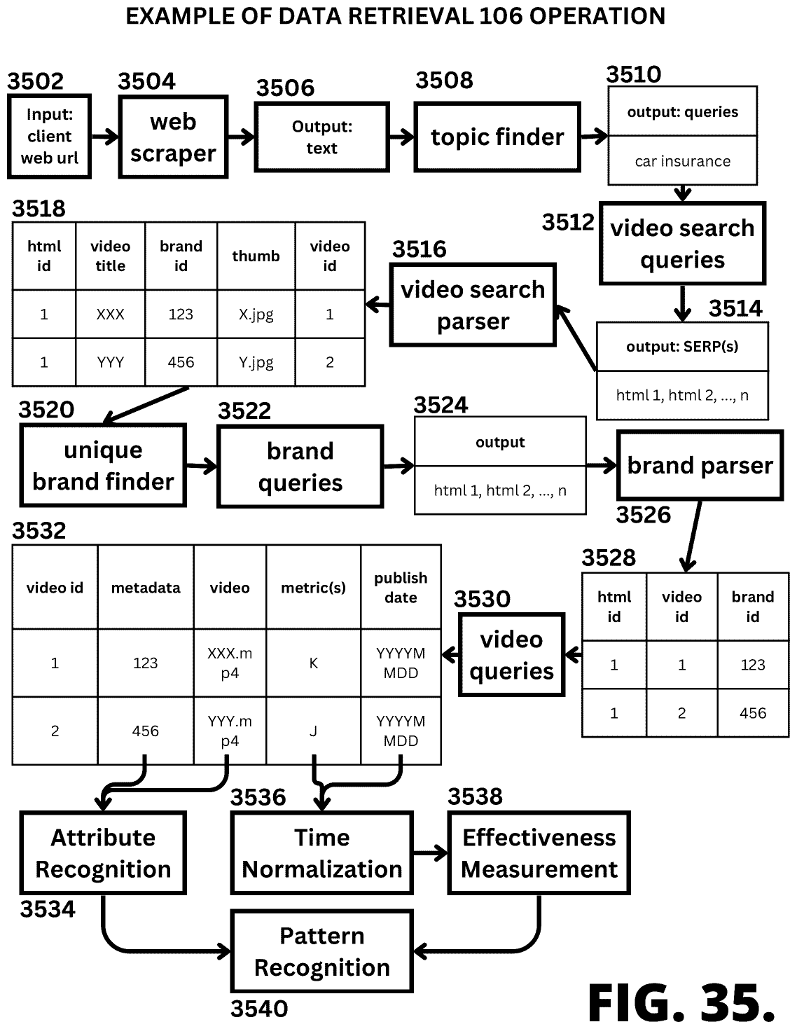

FIG. 35 exemplifies the operation of data retrieval 106, providing detailed insights into the specific operational steps within this component and their collective use in practice. This figure is instrumental in demonstrating how data retrieval is conducted in a versatile and iterative manner to expand the pool of content used for attribute recognition, effectiveness measurement, and pattern recognition.

In the example presented, a user's web URL, such as www.companyxyz.com, is utilized as input 3502 to a web scraper 3504. The web scraper retrieves content from the web location denoted by the input and outputs data 3506, which can be in various forms like HTML, XML, or textual representations thereof. This output data 3506 is then fed into a topic finder 3508, which performs summarization on output data 3506 using methods that often include but are not limited to topic modeling or text summarization techniques, including computation of the most common n-grams. Topic finder 3508 may also execute semantic expansion similar to that described in FIG. 31 (semantic expansion 3104). An example output from topic finder 3508 is illustrated in table 3510, containing phrases such as “car insurance”.

Table 3510 is used to seed video search queries 3512, akin to the process shown in FIG. 31 (video search queries 3108). In this case, video search queries 3512 is configured to output and store search engine results pages (SERPs) associated with each input from table 3510. The example output from video search queries 3512 is depicted in table 3514. Table 3514 then becomes the input for video search parser 3516, which parses the SERPs to identify each unique piece of video content, its brand sponsor, and other metadata, as shown in a simplified form in table 3518.

Table 3518 serves as the input for unique brand finder process 3520, tasked with identifying all the brand sponsors associated with the videos found in the prior step. These unique brands are output by process 3520 and utilized as input for brand queries 3522. Brand queries 3522 retrieves SERPs from search engines and/or video platform.

Table 3524, containing SERPs related to audiovisual content for specific brand sponsors, is then inputted into a brand parser 3526. This parser processes each SERP for every respective brand, outputting one row per video identified for each brand, as shown in table 3528. Table 3528 becomes the input for video queries 3530; video queries 3530 mirrors the process shown in FIG. 31 (video search queries 3108). The metadata associated with each row in table 3528 is used to generate queries for retrieving further SERPs, the output of which is illustrated in table 3532, showing one row per video, including a video identifier, metadata, video content or pointer to video content, and various metrics.

The metadata and/or video content from table 3532 are then used as input for attribute recognition 3534, which corresponds to attribute recognition 108 of FIG. 1. In parallel, metrics and/or publication date from table 3532 are inputs for time normalization 3536, the output of which is used for effectiveness measurement 3538. Time normalization 3536 aligns with time normalization 112 in FIG. 1, and effectiveness measurement 3538 corresponds to effectiveness measurement 110 in FIG. 1. In some embodiments, metrics and publication date may be passed directly to effectiveness measurement 3538 without a time normalization step.

The outputs from attribute recognition 3534 and effectiveness measurement 3538 are then inputs for pattern recognition 3540, which corresponds to pattern recognition 114 of FIG. 1.

A noteworthy aspect of the data retrieval 106 is the flexibility in the source of the web url 3502 used as the input. Specifically, it is important to recognize that web url 3502 need not be exclusively associated with the user of the video optimization system. Instead, this URL can represent a wide range of web locations, including but not limited to a competitor's website or any other relevant online location.

Another significant aspect is the modular nature of the components within the data retrieval operation (106), allowing for flexibility in their use. Specifically, components can be skipped or reordered based on the specific requirements of the system's users. This modular approach enhances the system's adaptability.

For instance, in scenarios where users already have a specific topic for which they wish to generate optimized audiovisual content, the process depicted in FIG. 35 can be streamlined by directly inputting these user-provided topics into Table 3510 or passing them directly into video search queries 3512. This direct input allows for the omission of preceding steps such as 3502 (input of a web URL), 3504 (web scraping), 3506 (output from the web scraper), and 3508 (topic finder). By bypassing these steps, the system can efficiently focus on the user-specified topic, reducing the time and resources required for data retrieval and processing.

Another exemplary instance of the system's versatility is its ability to perform any of the queries denoted by 3512, 3522, and 3530 on data that has already been gathered and previously stored in Data 106 (as referenced in FIG. 1), without necessitating further external queries. For example, if a new user seeks to develop optimized audiovisual content for a sector like car insurance, where the video optimization system has already accumulated extensive data, video search queries 3512 can retrieve data already stored in Data 106. This approach yields retrieved output consistent with table 3514, efficiently utilizing previously collected information.

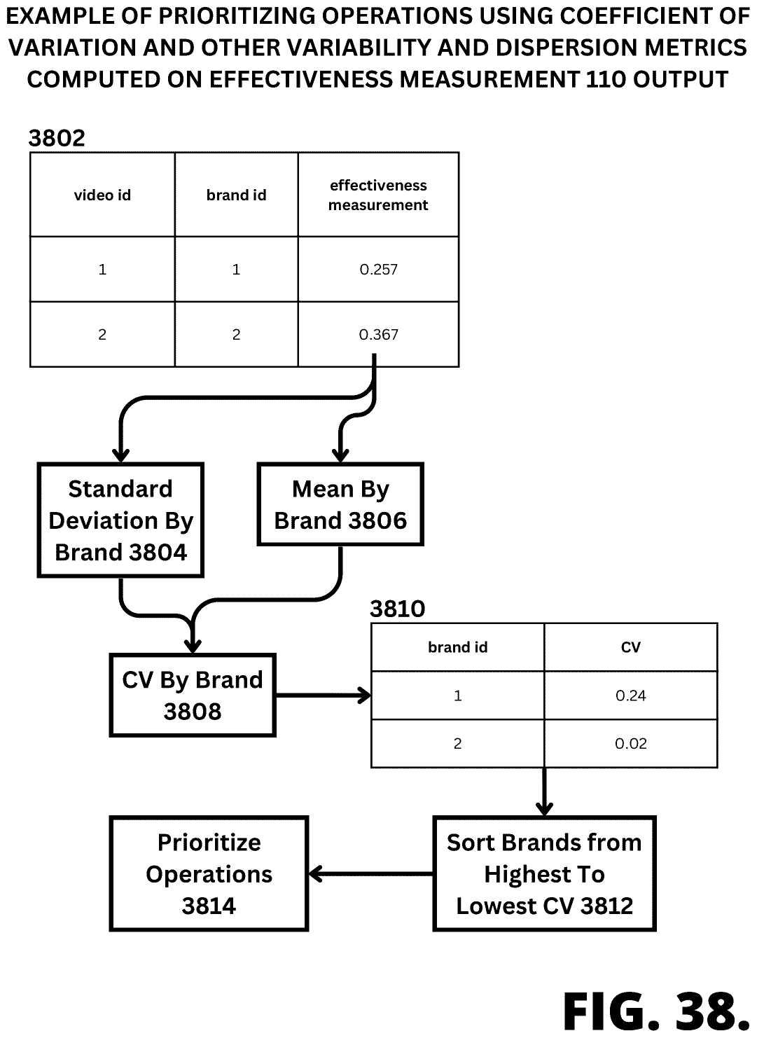

The capacity to internally retrieve data while skipping or reordering certain steps is further exemplified in a scenario where a system user aims to identify significant brand influencers in the video domain. Using data previously gathered, including tables 3518, 3528, 3532, and 3528, the system can search the metadata column of table 3532 and/or outputs of Attribute Recognition 3534 using a user-provided topic like “car insurance” entered into table 3510. By linking back to tables 3528 and 3518, the system can identify which brands and/or influencers are producing the most content related to this topic. Metrics and scores can be propagated during these joins, enabling the computation of valuable metrics such as identifying influencers and competitor brands with the most performant video content in the topic space, influencers and brands conducting extensive audiovisual testing, and influencers and brands yielding the most informative data for learning purposes, as outlined in techniques like those depicted in FIG. 38.

In practice, the pre-computation of various database views, materialized views, and indexes is often desirable to expedite calculations for users. For example, an index containing a row for each unique brand, with a key comprising a concatenation and encoding of each brand's video metadata and detected attributes across all its videos, can significantly speed up the determination of nearby competitor brands and/or video influencers based on user input or other data as shown in Table 3510.

FIG. 35 thus illustrates the comprehensive, flexible, and iterative nature of data retrieval in the video optimization system, beginning with a single web URL for a user and culminating in a table containing potentially hundreds of thousands of unique videos with information relevant to predicting new performative content for the user. This process underscores the versatility of the system in utilizing diverse data gathering steps to enhance the scope and accuracy of attribute recognition, effectiveness measurement, and pattern recognition.

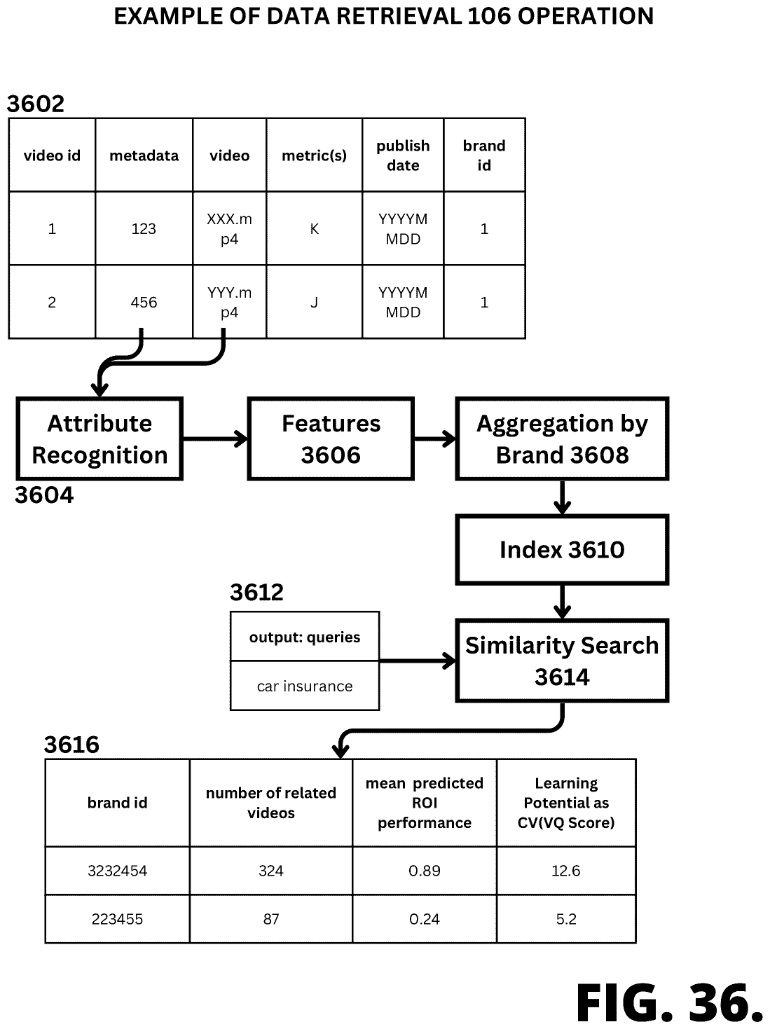

To further expand on the flexibility and use of pre-computed aggregations of Data 106, FIG. 36 presents an example of reordering the data retrieval operation 106 and incorporating aggregation by brand, indexing, and similarity search for identifying key brands and influencers relevant to the audiovisual optimization for a user. This figure starts with Table 3602, which contains one row per identified video along with associated metadata, a pointer to the video file, various metrics, the publication date, and a brand identifier. Table 3602 is analogous to Table 3532 in FIG. 35.

The metadata and video data portrayed in Table 3602 are inputted into attribute recognition (3604), corresponding to attribute recognition 108 of FIG. 1. The output of attribute recognition 3604 are features 3606, with one row per video and columns representing attributes for each video. These features are then used in an aggregation step, shown here as aggregation by brand 3608. Various aggregation functions may be employed, but a simple approach is to concatenate all features across videos by brand, outputting one row per brand and one or more columns representing aggregates of features presented via input 3602. In some embodiments, a single text column describing all of a brand's videos can be the features. The output of aggregation by brand 3608 can then be used as input into an indexing function to create index 3610, as previously described with FIG. 33 as an example.

A new input 3612 representing a topic of interest to a user is combined with index 3610 in a similarity search 3614 process, with FAISS being one example of such a process. This input is akin to Table 3510 in FIG. 35. The output of the similarity search 3614 is displayed as Table 3616, with one row per brand and/or influencer and columns showing a brand identifier and aggregated metrics associated with videos of the brand specified by the row's brand identifier. While simple aggregations of videos by brand, such as the number of related videos, can be output, data from effectiveness measurement 110 of FIG. 1, as well as other data associated with videos and brand sponsors, may be included as part of aggregation by brand 3608 and provided to index 3610 as values. Consequently, Table 3616 shows mean predicted ROI performance across the videos for each brand ID, as well as the learning potential achievable by studying each associated brand's videos, portrayed here as a coefficient of variation of the VQ score, a topic to be discussed in FIG. 38.

In summary, FIG. 36 demonstrates the system's adaptability in handling complex data queries, use of aggregation steps, and its ability to reorder operations for efficiency and targeted analysis. This adaptability allows the system to quickly identify influential and/or competitive brands and influencers in the audiovisual realm, crucial for optimizing content creation and marketing strategies.

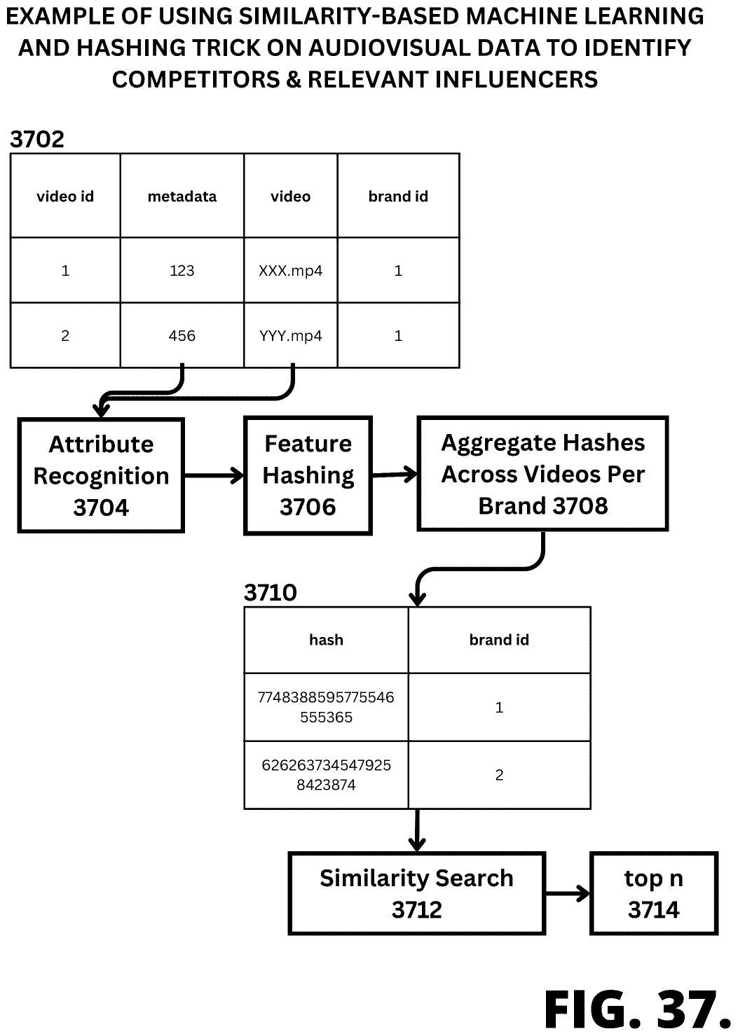

FIG. 37 in the patent outlines a method that employs similarity-based machine learning and a feature hashing technique for rapidly identifying competitors and relevant influencers in the domain of audiovisual content. This process, akin to that described in FIG. 36, emphasizes the use of a feature hashing trick to enable more rapid retrieval of brands and influencers producing similar audiovisual content to that which interests a user of the system.

The process begins with Table 3702, analogous to Tables 3602 in FIGS. 36 and 3532 in FIG. 35, containing one row per identified video along with corresponding metadata, a pointer to the video file, various metrics, publication date, and a brand identifier. The metadata and associated video data within Table 3702 are processed through attribute recognition 3704, mirroring attribute recognition 108 in FIG. 1. The output of attribute recognition 3704 is then inputted into a feature hashing step 3706, where a highly summarized entry of each video's features is created, typically resulting in a single string representation for each video.

This output from feature hashing 3706 undergoes aggregation across videos by brand, as illustrated in the aggregation by brand step 3708. The resultant output forms a table, as shown in Table 3710, containing a summary hash for each brand that encapsulates the essence of all video content associated with the corresponding brand ID on the same row. This table can then be used to create an index and perform similarity search 3712, akin to similarity search 3614 in FIG. 36, using a new input 3612.

The output from similarity search 3712 is versatile and can be presented in various forms, including a list of the nearest competing brands or influencers (top n 3714) or a table similar to Table 3616 in FIG. 36. The feature hashing technique, as depicted in FIG. 37, exemplifies how query and analysis times related to audiovisual content is reduced to mere milliseconds, enhancing the system's efficiency and responsiveness.

FIG. 38 demonstrates a method employed by the invention to expedite audiovisual optimization by prioritizing operations using the coefficient of variation and other variability and dispersion metrics computed on the output of effectiveness measurement 110.

The figure begins with Table 3802, akin to Tables 3702, 3602, and 3532 from FIGS. 37, 36, and 35, respectively. This table includes one row per video with a video identifier, a brand identifier, and at least one associated effectiveness measurement output from effectiveness measurement 110 of FIG. 1.

By calculating the standard deviation of one or more effectiveness measurements by brand ID (as performed by standard deviation by brand 3804), and the mean of one or more effectiveness measurements by brand (as done by mean by brand 3806), the outputs are used to compute a coefficient of variation, depicted as CV by brand 3808. The resultant data is shown in Table 3810, which can be sorted in various ways, such as sorting brands from highest to lowest CV 3812. The order of output 3812 can be used to prioritize operations 3814, including which data should undergo attribute recognition 108 of FIG. 1 and in what order.

In some embodiments, if a brand's coefficient of variation on an effectiveness measurement is sufficiently small, further analysis of that brand's videos may be omitted, as a low CV suggests insufficient variability in that brand's video performance to learn anything valuable. Conversely, a high coefficient of variation indicates that a brand's videos exhibit high performance variation, suggesting significant learning potential from studying which videos performed well and which did not.

FIG. 38 thus illustrates a major method for curtailing unnecessary analysis and avoiding expensive GPU usage, particularly incurred during attribute recognition 108. By detecting brands whose videos do not offer informative data for the system's goals, the cost of GPU processing for those videos' attributes is avoided, enhancing the efficiency and cost-effectiveness of the video optimization process. Meanwhile, brands with more informative video content can be prioritized for analysis, including Attribute Recognition 108 and Pattern Recognition 114 of FIG. 1.

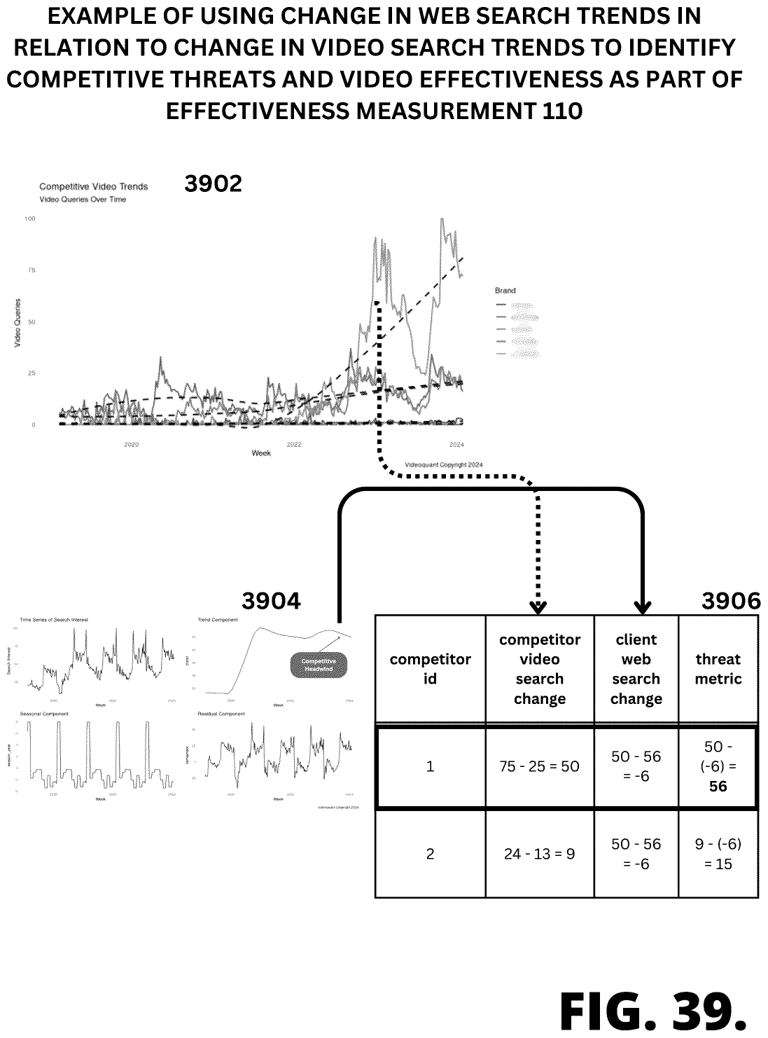

FIG. 39 demonstrates an innovative approach to using changes in web search trends in conjunction with video search trends to identify competitive threats and evaluate video effectiveness, as part of effectiveness measurement 110. This method is particularly useful in understanding the competitive landscape and assessing the impact of audiovisual content in the market.

The figure begins with a plot 3902 that illustrates video search trends gathered by data retrieval 106. Each line in this plot represents a specific brand, with the Y-axis denoting an index of query volume related to the brand and the X-axis representing time, with several years shown. Notably, the plot reveals a brand whose video query trends are significantly growing in comparison to others, indicated by an upward trending dotted line.

The brands featured in plot 3902 are competitors of a user of the system, identified using processes detailed in FIGS. 36 and 37. Alternatively, users can provide their own list of competitors. Plots 3904 represent web search trends for the brand user of the system, with a focus on detecting seasonal trends and overall search trend patterns over the same period as the video query trends in plot 3902. By comparing the trend of a user's own brand web search query volume to that of competitor video search trends over the same period of time, competitive threats associated with audiovisual content can be identified and quantified.

Table 3908 demonstrates a method for identifying competitive threats and their magnitudes by computing differences between changes in competitor video search trends and a user's web search trend. Each competitor line in plot 3902 corresponds to a row in table 3906, where the difference in video queries over time (column two) is compared with changes in the user's own web searches (column three). The threat metric in column four indicates the level of competitive threat, with higher values signifying a larger threat.

While the computation in table 3906 is a simplified version of the process typically used, a more advanced approach involves computing the magnitude and statistical significance of negative correlations between the trends in plot 3902 and that depicted in 3904. Larger magnitude negative and statistically significant correlations indicate a greater competitive threat.

In addition to detecting competitive threats, this data can also be used to prioritize which brands and corresponding video content are analyzed first, akin to the prioritization shown in prioritize operations 3814 of FIG. 38. This approach helps to shortcut unnecessary analysis and avoid costly GPU processing.

FIG. 40 provides an illustrative embodiment of attribute recognition 108, specifically tailored for handling augmented reality (AR), virtual reality (VR), and higher-dimensional audiovisual data. This figure builds upon the concepts introduced in FIG. 5, where audiovisual data 502 includes not just traditional media but also encompasses AR, VR, and even media engaging additional senses such as touch and smell. The versatility of the invention allows for consistent operation across these varied forms of audiovisual data.

In this figure, we focus on the application of the invention to higher-dimensional audiovisual data, particularly as experienced through AR and VR technologies. A 3D representation, labeled 4002, is used to depict a scenario within a three-dimensional space. This representation shows a man positioned towards the front left of the 3D space. A subsequent representation, labeled 4004, illustrates the same space and man at a later time, where the man has moved to the back right of the 3D space. This temporal shift highlights the dynamic nature of the content within AR and VR environments.

Key to processing this data is the concept of reducing higher-dimensional spaces into lower-dimensional frames for easier analysis. In this context, 2D slices 4006 and 4008 serve as representative snapshots of the 3D spaces 4002 and 4004, respectively. These 2D slices are critical in transforming the complex 3D data into a more manageable form. 2D slices 4006 capture the initial state of the 3D space, while 2D slices 4008 represent its state at a later time.

Comparative analysis of these 2D slices, both within and between 4006 and 4008, is then undertaken to form a matrix representation 4010. This matrix is a structured representation of the changes and movements observed in the 3D space over time. It offers a detailed view of the dynamics within the AR or VR environment, distilled into a more computationally manageable format. Additionally, there is an option to encode this matrix representation 4010, which serves to reduce memory requirements, thereby optimizing the processing workflow.

Subsequent to this transformation, further processing 4012 is carried out by attribute recognition 108 on the data represented by matrix 4010. This processing aligns with the methods described in great detail earlier, where the attribute recognition system analyzes and interprets the data, extracting meaningful insights and characteristics from the complex, high-dimensional audiovisual content. This process underlines the capability of the invention to adapt and manage diverse forms of media, ranging from conventional 2D videos to the more complex and dynamic realms of AR and VR.

Expanding further on the concept of processing higher dimensionality spaces, such as those in theoretical fourth or fifth dimensions, the methodology outlined in FIG. 40 can be iteratively applied to these complex environments, each with their own encoding layers to compress data between steps. In a hypothetical five-dimensional (5D) environment, the first step involves representing this space using four-dimensional (4D) frames. This initial breakdown is crucial as it simplifies the 5D data into a format that is one step closer to conventional three-dimensional understanding. Each of these 4D frames encapsulates a unique slice of the 5D space, capturing both spatial and temporal dimensions.

Once the 5D environment is segmented into 4D frames, the process further iteratively decomposes each 4D frame into three-dimensional (3D) frames. This step effectively reduces the complexity of the data, bringing it into a realm more akin to traditional VR and AR environments. Each 3D frame extracted from the 4D space offers a snapshot that is more comprehensible and easier to analyze. These 3D frames are then further distilled into two-dimensional (2D) slices, much like the process described for 3D spaces in FIG. 40. This iterative breakdown through dimensions, from 5D to 4D to 3D and finally to 2D, allows for a systematic and manageable analysis of what initially is extremely complex and high-dimensional data.

The significance of this method lies in its ability to handle data of any arbitrarily high dimensionality, making it an incredibly versatile tool in the field of attribute recognition. By systematically reducing the dimensionality of the data at each stage, the method ensures that the essential characteristics and dynamics of the original space are retained and translated into a more accessible format. This approach not only simplifies the computational requirements but also opens up new possibilities for analyzing and interpreting data from futuristic technologies and complex simulations, where higher-dimensional spaces might be more commonly encountered. The ultimate goal of this process is to render even the most intricate and multidimensional environments into a format that can be effectively processed, analyzed, and understood using existing technological frameworks and analytical methodologies.

In summary, disclosed is a series of methods that expand on the Related Applications. Starting with the foundational schematic of the system's components in FIG. 1, subsequent figures (FIG. 2 through FIG. 40) detail the implementation of various components, ranging from visual question answering, image captioning techniques, text mining methods, integration of various attribute recognition methodologies, and the innovative use of generative models for feature generation. The integration of outputs from attribute recognition and effectiveness measurement is explored, highlighting their role in pattern recognition to determine correlations between audiovisual attributes and performance metrics. The adaptability of the system to accommodate different data formats and structures, along with the innovative use of generative models for fine-tuning and output generation, is emphasized. This filing further delves into the practical application of these components in a web portal interface, illustrating how complex analytical insights are translated into actionable, user-friendly information having large and consequential financial impact. Application of efficient similarity search, central tendency measures, feature hashing, and machine learning techniques for rapid content evaluation and optimization are disclosed in detail. The role of data retrieval in expanding the content pool for analysis and the use of web search trends to evaluate video effectiveness and identify competitive threats are disclosed in detail, culminating in a holistic view of a state-of-the-art system designed to change the way audiovisual content is analyzed, optimized, and utilized in various applications.

What is claimed is:

1. A method for optimizing audiovisual content, comprising:
a. Receiving a data stream of audiovisual content;
b. Applying attribute recognition to the data stream, comprising:
i. Processing the data stream through a generative model to generate a descriptive intermediary output with reduced dimensionality relative to the original data stream;
ii. Generating a feature set from the descriptive intermediary output for analysis by a machine learning model, the feature set including, but not limited to, representations of elements such as color schemes, audio patterns, entities, entity interactions, and narrative structures;
c. Evaluating the effectiveness of the audiovisual content using a machine learning model;
d. Integrating outputs from the attribute recognition and effectiveness evaluation for pattern recognition;
e. Generating optimized audiovisual content based on identified patterns.

2. A system for enhancing the effectiveness of audiovisual content, comprising:
a. A processor configured to execute instructions for processing data streams of audiovisual content;
b. A memory storing said instructions and necessary data for said processing;
c. A generative model operational within said system for generating predictive outputs from audiovisual content;
d. An attribute recognition module for analyzing characteristics of the audiovisual content;
e. An effectiveness measurement module for assessing the performance of the audiovisual content;
f. A pattern recognition module for establishing correlations between the attributes and performance metrics;
g. An output generation module for creating optimized audiovisual content;
h. A communication interface module for disseminating results and facilitating user interaction, capable of supporting various communication formats including, but not limited to, a web portal interface and application programming interface (API).

3. A computer-implemented process for optimizing audiovisual content, involving:
a. Retrieving data from diverse audiovisual sources;
b. Processing said data for attribute recognition;
c. Analyzing the effectiveness of the audiovisual content using a generative model;
d. Employing pattern recognition to establish correlations between audiovisual attributes and their effectiveness;
e. Adapting outputs to optimize future audiovisual content creation.

4. The method of claim 1, wherein said generative model is selected from a group consisting of Large Language Models (LLM), Large Multimodal Models (LMM), Variational Autoencoders (VAE), Generative Adversarial Networks (GAN), Convolutional Neural Networks (CNN), Recurrent Neural Networks (RNN), and Transformer Models.

5. The method of claim 1, wherein the generative model is used to generate a text-based intermediary as the descriptive intermediary output, and is utilized to perform functions including generating descriptive text that characterizes or explains aspects of the audiovisual content.

6. The method of claim 1, wherein generating a feature set utilizes text mining methods for transforming said descriptive intermediary output from said generative model into structured data; said text mining methods includes at least one of tokenization and encoding.

7. The method of claim 1, wherein the audiovisual content includes augmented reality or virtual reality content.

8. The method of claim 1, wherein the effectiveness evaluation includes at least one measure of uncertainty, such as a statistical confidence band, to indicate reliability of effectiveness scores.

9. The method of claim 1, wherein the pattern recognition module employs a machine learning algorithm demonstrating effectiveness in handling high feature dimensionality such as XGBoost and LightGBM.

10. The method of claim 1, wherein the processing of said data stream includes semantic expansion to broaden the scope of data analysis.

11. The method of claim 1, further comprising employing SHAP values to assign importance to individual features within the audiovisual content.

12. The method of claim 1, wherein the optimization of audiovisual content includes at least one objective selected from increased user engagement, viewer retention, revenue, return on investment, and advertising effectiveness.

13. The method of claim 1, further comprising performing a central tendency analysis on the outputs of the generative model.

14. The system of claim 2, wherein said attribute recognition module utilizes a feature hashing and indexing technique for rapid data processing.

15. The system of claim 2, wherein said pattern recognition module uses transfer learning techniques for data analysis.

16. The system of claim 2, wherein said output generation module employs at least one technique for quantifying uncertainty, including but not limited to bootstrapping and quantile regression, to facilitate determination of certainty in the generated outputs.

17. The system of claim 2, wherein the attribute recognition module incorporates chronological analysis of audiovisual content.

18. The system of claim 2, wherein the output generation module categorizes effectiveness scores into different performance levels.

19. The process of claim 3, wherein said processing for attribute recognition includes converting audiovisual inputs into descriptive intermediaries of lower dimensionality using a generative model.

20. The process of claim 3, wherein the optimization of future audiovisual content creation includes generating various outputs including outlines, descriptions, tags, scripts, storyboards, videos, augmented reality, virtual reality, or full audiovisual presentations.

21. The method of claim 1, further comprising:
a. Implementing an analysis of ordered results obtained from at least one source, which may include, but is not limited to, a search engine, social media platform, or video content platform, as a key component of the effectiveness evaluation process for the received data stream;
b. Deriving at least one performance characteristic of the audiovisual content based on the position, rank, or order in these ordered results;
c. Utilizing the derived performance characteristic to inform the effectiveness evaluation of the audiovisual content within the machine learning model;
d. Wherein the inferred performance characteristic is determined based on the content's position, rank, or order in the ordered results, thereby implying a correlation between these factors and the content's potential to fulfill predefined performance criteria.
